(19) United States
(12) Patent Application Publication
(10) Pub. No.: US 2026/0149813 A1
(43) Pub. Date: May 28, 2026

(54) VIDEO ENCODING METHOD AND APPARATUS, VIDEO DECODING METHOD AND APPARATUS, DEVICE, SYSTEM, AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(73) Assignee: GUANGDONG OPPO MOBILE TELECOMMUNICATIONS CORP., LTD., Dongguan (CN)

(21) Appl. No.: 19/401,349

(22) Filed: Nov. 25, 2025

Related U.S. Application Data
(63) Continuation of application No. PCT/CN2023/096641, filed on May 26, 2023.

(51) Int. Cl. H04N 19/159; H04N 19/105; H04N 19/176; H04N 19/196; H04N 19/593

(52) U.S. Cl. CPC H04N 19/159; H04N 19/105; H04N 19/176; H04N 19/196; H04N 19/593

(57) ABSTRACT

The present application provides a video encoding method and apparatus, a video decoding method and apparatus, a device, a system, and a storage medium. The method comprises: during prediction of a current chroma block, determining a prediction mode of the current chroma block; if the prediction mode is a cross-component intra-frame prediction mode, determining a limited range of a predicted value of the current chroma block, the limited range comprising at least one of a maximum limit value and a minimum limit value of the predicted value; then determining a first predicted value of the current chroma block on the basis of the cross-component intra-frame prediction mode; and determining a second predicted value of the current chroma block on the basis of the first predicted value and the limited range.

### CROSS-REFERENCE TO RELATED APPLICATIONS

This application is a continuation of International Application No. PCT/CN2023/096641, filed on May 26, 2023, the disclosure of which is hereby incorporated by reference in its entirety.

### TECHNICAL FIELD

This application relates to the field of video coding technologies, and in particular, to a video coding method, apparatus, and system, a device, and a storage medium.

### BACKGROUND

A digital video technology may be applied to a plurality of video apparatuses, such as a digital television, a smartphone, a computer, an electronic reader, or a video player. With development of video technologies, an amount of video data becomes increasingly large. To facilitate video data transmission, a video apparatus performs video compression, such that the video data is transmitted or stored more efficiently.

Since there is temporal or spatial redundancy in a video, the redundancy in the video may be eliminated or reduced by prediction, thereby improving compression efficiency. Currently, chroma prediction based on a cross component intra prediction mode has low accuracy.

### SUMMARY

Embodiments of this application provide a video coding method, apparatus, system, a device, and a storage medium, which may improve a prediction effect of a current chroma block and enhance coding performance.

According to a first aspect, this application provides a video decoding method, applied to a decoder. The video decoding method includes:
determining a prediction mode of a current chroma block;
in a case that the prediction mode is a cross component intra prediction mode, determining a limit range of a predicted value of the current chroma block based on a chroma value of a surrounding reconstructed region of the current chroma block, where the limit range includes at least one of a maximum limit value or a minimum limit value of the predicted value;
determining a first predicted value of the current chroma block based on the cross component intra prediction mode; and
determining a second predicted value of the current chroma block based on the first predicted value and the limit range.

According to a second aspect, an embodiment of this application provides a video encoding method, applied to an encoder. The video encoding method includes:
determining a prediction mode of a current chroma block;
in a case that the prediction mode is a cross component intra prediction mode, determining a limit range of a predicted value of the current chroma block based on a chroma value of a surrounding reconstructed region of the current chroma block, where the limit range includes at least one of a maximum limit value or a minimum limit value of the predicted value;
determining a first predicted value of the current chroma block based on the cross component intra prediction mode; and
determining a second predicted value of the current chroma block based on the first predicted value and the limit range.

According to a third aspect, this application provides a video decoding apparatus, configured to execute the method according to the first aspect or implementations of the first aspect. Specifically, the apparatus includes a functional unit configured to execute the method according to the first aspect or implementations of the first aspect.

According to a fourth aspect, this application provides a video encoding apparatus, configured to execute the method according to the second aspect or implementations of the second aspect. Specifically, the apparatus includes a functional unit configured to execute the method according to the second aspect or implementations of the second aspect.

According to a fifth aspect, this application provides a video decoder, which includes a processor and a memory. The memory is configured to store a computer program, and the processor is configured to invoke and run the computer program stored in the memory to execute the method according to the first aspect or implementations of the first aspect.

According to a sixth aspect, this application provides a video encoder, which includes a processor and a memory. The memory is configured to store a computer program, and the processor is configured to invoke and run the computer program stored in the memory, to execute the method according to the second aspect or implementations of the second aspect.

According to a seventh aspect, this application provides a video coding system, which includes a video encoder and a video decoder. The video decoder is configured to execute the method according to the first aspect or implementations of the first aspect, and the video encoder is configured to execute the method according to the second aspect or implementations of the second aspect.

According to an eighth aspect, this application provides a chip, configured to implement the method according to either of the first aspect and the second aspect or implementations of either of the first aspect and the second aspect. Specifically, the chip includes: a processor, configured to invoke a computer program from a memory and run the computer program, so that a device on which the chip is installed executes the method according to either of the first aspect and the second aspect or implementations of either of the first aspect and the second aspect.

According to a ninth aspect, this application provides a computer-readable storage medium, configured to store a computer program. The computer program causes a computer to execute the method according to either of the first aspect and the second aspect or implementations of either of the first aspect and the second aspect.

According to a tenth aspect, this application provides a computer program product, including computer program instructions. The computer program instructions cause a computer to execute the method according to either of the first aspect and the second aspect or implementations of either of the first aspect and the second aspect.

According to an eleventh aspect, this application provides a computer program. The computer program, when being run on a computer, causes the computer to execute the method according to either of the first aspect and the second aspect or implementations of either of the first aspect and the second aspect.

### BRIEF DESCRIPTION OF DRAWINGS

FIG. 1 is a schematic block diagram of a video coding system according to an embodiment of this application.

FIG. 2 is a schematic block diagram of a video encoder according to an embodiment of this application.

FIG. 3 is a schematic block diagram of a video decoder according to an embodiment of this application.

FIG. 4A is a schematic diagram of intra prediction.

FIG. 4B is a schematic diagram of intra prediction.

FIG. 5A to FIG. 5I are schematic diagrams of intra prediction.

FIG. 6A is a schematic diagram of CCLM prediction.

FIG. 6B is a schematic diagram of a spatial location relationship of input to a cross convolution filter in CCCM.

FIG. 6C is a schematic diagram of a reconstructed region for determining a filter coefficient.

FIG. 6D is a schematic diagram of four sobel operators for acquiring a gradient in GLM.

FIG. 6E is a schematic diagram of adjacent locations of a current chroma block.

FIG. 7 is a schematic flowchart of a video decoding method according to an embodiment of this application.

FIG. 8A and FIG. 8B are schematic diagrams of reconstructed regions.

FIG. 9A to FIG. 9C are schematic diagrams of several reconstructed regions for determining model parameters in CCCM.

FIG. 10A to FIG. 10C are schematic diagrams of a first surrounding reconstructed region corresponding to FIG. 9A to FIG. 9C, respectively.

FIG. 11A to FIG. 11E are schematic diagrams of a first surrounding reconstructed region.

FIG. 12 is a schematic flowchart of a prediction method according to an embodiment of this application.

FIG. 13 is a schematic block diagram of a video decoding apparatus according to an embodiment of this application.

FIG. 14 is a schematic block diagram of a video encoding apparatus according to an embodiment of this application.

FIG. 15 is a schematic block diagram of an electronic device according to an embodiment of this application.

FIG. 16 is a schematic block diagram of a video coding system according to an embodiment of this application.

### DESCRIPTION OF EMBODIMENTS

This application may be applied to the fields of picture coding, video coding, hardware video coding, dedicated circuit video coding, real-time video coding, and the like. For example, solutions of this application may be combined with an audio video coding standard (AVS for short), such as the H.264/audio video coding (AVC for short) standard, the H.265/high efficiency video coding (HEVC for short) standard, and the H.266/versatile video coding (VVC for short) standard. Alternatively, solutions of this application may be implemented in conjunction with other proprietary or industry standards, including ITU-TH.261, ISO/IECMPEG-1 Visual, ITU-TH.262 or ISO/IECMPEG-2Visual, ITU-TH.263, ISO/IECMPEG-4Visual, and ITU-TH.264 (also referred to as ISO/IECMPEG-4AVC), including scalable video coding (SVC) and multiview video coding (MVC) extensions. It should be understood that technologies in this application are not limited to any specific coding standard or technology.

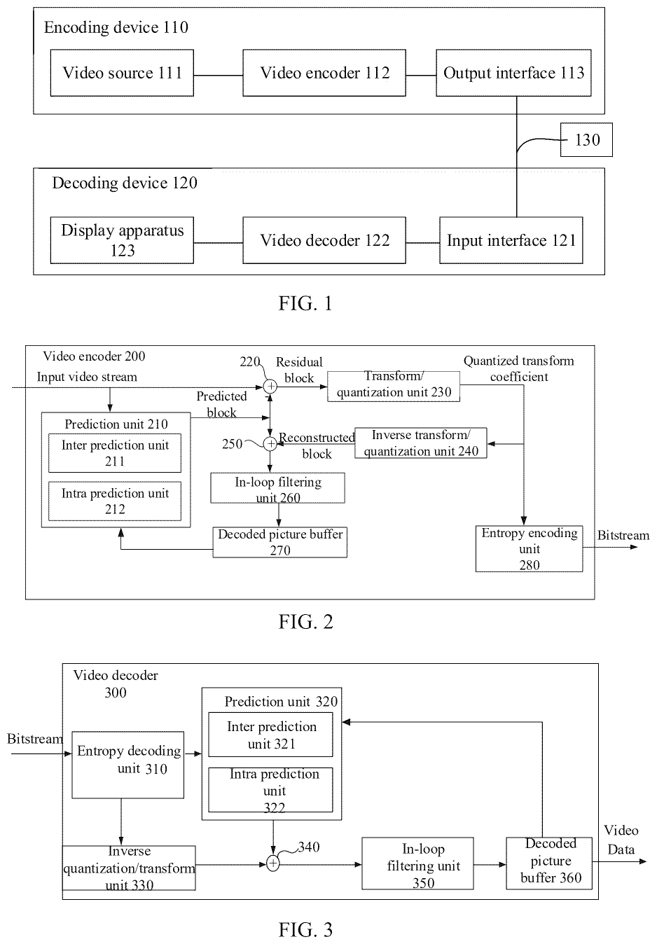

For ease of understanding, a video coding system in embodiments of this application is first described with reference to FIG. 1.

FIG. 1 is a schematic block diagram of a video coding system according to an embodiment of this application. It should be noted that, FIG. 1 is merely an example, and the video coding system in embodiments of this application includes but is not limited to that shown in FIG. 1. As shown in FIG. 1, the video coding system 100 includes an encoding device 110 and a decoding device 120. The encoding device is configured to encode (which may be understood as compressing) video data to generate a bitstream, and transmit the bitstream to the decoding device. The decoding device decodes the bitstream generated by encoding by the encoding device, to obtain decoded video data.

In embodiments of this application, the encoding device 110 may be understood as a device having a video encoding function, and the decoding device 120 may be understood as a device having a video decoding function. That is, the encoding device 110 and the decoding device 120 in embodiments of this application include a wider variety of apparatuses, such as a smartphone, a desktop computer, a mobile computing apparatus, a notebook (for example, laptop) computer, a tablet computer, a set-top box, a television, a camera, a display apparatus, a digital media player, a video game console, and a vehicle-mounted computer.

In some embodiments, the encoding device 110 may transmit the encoded video data (for example, the bitstream) to the decoding device 120 via a channel 130. The channel 130 may include one or more media and/or apparatuses capable of transmitting the encoded video data from the encoding device 110 to the decoding device 120.

In an example, the channel 130 includes one or more communication media that cause the encoding device 110 to directly transmit the encoded video data to the decoding device 120 in real time. In this example, the encoding device 110 may modulate the encoded video data according to a communication standard, and transmit the modulated video data to the decoding device 120. The communication media include wireless communication media, such as radio frequency spectrum. Optionally, the communication media may further include wired communication media, such as one or more physical transmission cables.

In another example, the channel 130 includes a storage medium. The storage medium may store the video data encoded by the encoding device 110. The storage medium includes a plurality of types of locally accessible data storage media, such as an optical disk, a DVD, and a flash memory. In this example, the decoding device 120 may obtain the encoded video data from the storage medium.

In another example, the channel 130 may include a storage server. The storage server may store the video data encoded by the encoding device 110. In this example, the decoding device 120 may download the stored encoded video data from the storage server. Optionally, the storage server may store the encoded video data and transmit the encoded video data to the decoding device 120, such as a web server (for example, for a website) or a file transfer protocol (FTP) server.

In some embodiments, the encoding device 110 includes a video encoder 112 and an output interface 113. The output interface 113 may include a modulator/demodulator (modem) and/or a transmitter.

In some embodiments, in addition to the video encoder 112 and the input interface 113, the encoding device 110 may include a video source 111.

The video source 111 may include at least one of a video collection apparatus (for example, a video camera), a video archive, a video input interface, or a computer graphics system, where the video input interface is configured to receive video data from a video content provider, and the computer graphics system is configured to generate video data.

The video encoder 112 encodes the video data from the video source 111 to generate a bitstream. The video data may include one or more pictures (picture) or a sequence of pictures (sequence of pictures). The bitstream includes encoded information of the pictures or the sequence of pictures in the form of a stream of bits. The encoded information may include encoded picture data and associated data. The associated data may include a sequence parameter set (SPS for short), a picture parameter set (PPS for short), and other syntax structures. The SPS may include parameters applicable to one or more sequences. The PPS may include parameters applicable to one or more pictures. A syntax structure refers to a set of zero or more syntax elements arranged in specified order in the bitstream.

The video encoder 112 directly transmits the encoded video data to the decoding device 120 via the output interface 113. The encoded video data may also be stored on a storage medium or a storage server for subsequent retrieval by the decoding device 120.

In some embodiments, the decoding device 120 includes an input interface 121 and a video decoder 122.

In some embodiments, in addition to the input interface 121 and the video decoder 122, the decoding device 120 may include a display apparatus 123.

The input interface 121 includes a receiver and/or a modem. The input interface 121 may receive the encoded video data via the channel 130.

The video decoder 122 is configured to decode the encoded video data to obtain decoded video data, and transmit the decoded video data to the display apparatus 123.

The display apparatus 123 displays the decoded video data. The display apparatus 123 may be integrated with the decoding device 120 or arranged outside the decoding device 120. The display apparatus 123 may include a plurality of types of display apparatuses, such as a liquid crystal display (LCD), a plasma display, an organic light-emitting diode (OLED) display, or other types of display apparatuses.

In addition, FIG. 1 is merely an example. Technical solutions of embodiments of this application are not limited to FIG. 1, for example, the technologies in this application may also be applied to video encoding on a single side or video decoding on a single side.

The following describes a video encoding framework in embodiments of this application.

FIG. 2 is a schematic block diagram of a video encoder according to an embodiment of this application. It should be understood that, the video encoder 200 may be configured to perform lossy compression on a picture, and may also be configured to perform lossless compression on a picture. The lossless compression may be visually lossless compression, or may be mathematically lossless compression.

The video encoder 200 may be applied to picture data in a luminance-chrominance (YCbCr, YUV) format. For example, a YUV ratio may be 4:2:0, 4:2:2, or 4:4:4. Y denotes luma (Luma), Cb (U) denotes blue chroma, Cr (V) denotes red chroma, and U and V denote chroma (Chroma) used for describing color and saturation. For example, in terms of a color format, 4:2:0 indicates that every four pixels have four luma components and two chroma components (YYYYCbCr), 4:2:2 indicates that every four pixels have four luma components and four chroma components (YYYYCbCrCbCr), and 4:4:4 indicates full-pixel display (YYYYCbCrCbCrCbCrCbCr).

For example, the video encoder 200 reads video data, and partitions each frame of picture in the video data into a plurality of coding tree units (CTU). In some examples, a CTB may be referred to as a “tree block”, a “largest coding unit” (LCU for short), or a “coding tree block” (CTB for short). Each CTU may be associated with a pixel block of an equal size within the picture. Each pixel may correspond to one luma (luminance or luma) sample and two chroma (chrominance or chroma) samples. Therefore, each CTU may be associated with one luma sampling block and two chroma sampling blocks. A CTU size is, for example, 128×128, 64×64, 32×32, or the like. A CTU may be further partitioned into a plurality of coding units (CU) for encoding, and each CU may be a rectangular block or a square block. A CU may be further partitioned into prediction units (PU for short) and transform units (TU for short), thereby separating encoding, prediction, and transform from each other to implement more flexible processing. In an example, a CTU is partitioned into CUs by using a quadtree structure, and each CU is partitioned into TUs and PUs by using a quadtree structure.

The video encoder and the video decoder may support various PU sizes. Assuming that a particular CU size is 2N×2N, the video encoder and the video decoder may support PU sizes of 2N×2N or N×N for intra prediction, and may support symmetric PU sizes of 2N×2N, 2N×N, N×2N, N×N, or similar sizes for inter prediction. The video encoder and the video decoder may also support asymmetric PU sizes of 2N×nU, 2N×nD, nL×2N, and nR×2N for inter prediction.

In some embodiments, as shown in FIG. 2, the video encoder 200 may include a prediction unit 210, a residual unit 220, a transform/quantization unit 230, an inverse transform/quantization unit 240, a reconstruction unit 250, an in-loop filtering unit 260, a decoded picture buffer 270, and an entropy encoding unit 280. It should be noted that, the video encoder 200 may include more, fewer, or different functional components.

Optionally, in this application, a current block may be referred to as a current coding unit (CU), a current prediction unit (PU), or the like. A predicted block may also be referred to as a predicted picture block or a picture predicted block, and a reconstructed picture block may also be referred to as a reconstructed block or a picture reconstructed picture block.

In some embodiments, the prediction unit 210 includes an inter prediction unit 211 and an intra prediction unit 212. Due to a strong correlation between adjacent pixels within a frame in a video, an intra prediction method is used in video coding technologies to eliminate spatial redundancy between adjacent pixels. Due to strong similarity between adjacent frames in a video, an inter prediction method is used in video coding technologies to eliminate temporal redundancy between adjacent frames, thereby improving encoding efficiency.

The inter prediction unit 211 may be configured to perform inter prediction. The inter prediction may include motion estimation and motion compensation, and picture information of different frames may be referenced. In inter prediction, a reference block is found in a reference frame based on motion information, and a predicted block is generated based on the reference block to eliminate temporal redundancy. Frames used for inter prediction may be P-frames and/or B-frames. A P-frame refers to a forward-predicted frame, and a B-frame refers to a bidirectionally predicted frame. In inter prediction, a reference block is found in a reference frame based on motion information, and a predicted block is generated based on the reference block. The motion information includes a reference frame list where the reference frame is located, a reference frame index, and a motion vector. The motion vector may point to an integer-pixel location or a sub-pixel location. If the motion vector points to a sub-pixel location, interpolation filtering is required to be performed within the reference frame to obtain a required sub-pixel block. Herein, an integer-pixel or sub-pixel block found in the reference frame based on the motion vector is referred to as a reference block. In some technologies, a reference block is directly used as a predicted block. In some other technologies, further processing is performed on the reference block to generate a predicted block. Further processing being performed on the reference block to generate a predicted block may also be understood as using the reference block as the predicted block and then performing further processing on the predicted block to generate a new predicted block.

The intra prediction unit 212 predicts pixel information within a current coding picture block by referring only to information in a same frame of picture, so as to eliminate spatial redundancy. A frame used for intra prediction may be an I-frame.

For intra prediction, there are a plurality of prediction modes. For example, according to the H-series international digital video coding standards, the H.264/AVC standard defines 8 angular prediction modes and 1 non-angular prediction mode, and the H.265/HEVC standard extends this to 33 angular prediction modes and 2 non-angular prediction modes. Intra prediction modes used in HEVC include a planar mode (Planar), a DC mode, and 33 angular modes, totaling 35 prediction modes. Intra modes used in VVC include a planar mode, a DC mode, and 65 angular modes, totaling 67 prediction modes.

It should be noted that, as a quantity of angular modes increases, intra prediction becomes more precise, and better meets requirements generated due to development of high-definition and ultra-high-definition digital videos.

The residual unit 220 may generate a residual block of a CU based on a pixel block of the CU and a predicted block of a PU of the CU. For example, the residual unit 220 may generate the residual block of the CU such that each sample within the residual block has a value equal to a difference between the following two: a sample within the pixel block of the CU and a corresponding sample within the predicted block of the PU of the CU.

The transform/quantization unit 230 may quantize a transform coefficient. The transform/quantization unit 230 may quantize a transform coefficient associated with a TU of the CU based on a quantization parameter (QP) value associated with the CU. The video encoder 200 may adjust, by adjusting the QP value associated with the CU, a degree of quantization applied to the transform coefficient associated with the CU.

The inverse transform/quantization unit 240 may apply inverse quantization and inverse transform to the quantized transform coefficient to reconstruct the residual block from the quantized transform coefficient.

The reconstruction unit 250 may add a sample of the reconstructed residual block to a corresponding sample of one or more predicted blocks generated by the prediction unit 210, to generate a reconstructed picture block associated with the TU. In this way, a sampling block of each TU of the CU is reconstructed, and the video encoder 200 may reconstruct the pixel block of the CU.

The in-loop filtering unit 260 is configured to process an inverse-transformed and inverse-quantized pixel to compensate for distortion information, so as to provide better reference for subsequent pixel encoding. For example, the in-loop filtering unit may perform a deblocking filtering operation to reduce block artifacts of the pixel block associated with the CU.

In some embodiments, the in-loop filtering unit 260 includes a deblocking filtering unit and a sample adaptive offset/adaptive loop filtering (SAO/ALF) unit, where the deblocking filtering unit is configured to remove block artifacts and the SAO/ALF unit is configured to remove ringing artifacts.

The decoded picture buffer 270 may store the reconstructed pixel block. The inter prediction unit 211 may perform inter prediction on a PU of another picture by using a reference picture including the reconstructed pixel block. In addition, the intra prediction unit 212 may perform intra prediction on another PU in a same picture as the CU by using the reconstructed pixel block in the decoded picture buffer 270.

The entropy encoding unit 280 may receive the quantized transform coefficient from the transform/quantization unit 230. The entropy encoding unit 280 may perform one or more entropy encoding operations on the quantized transform coefficient to generate entropy encoded data.

FIG. 3 is a schematic block diagram of a video decoder according to an embodiment of this application.

As shown in FIG. 3, the video decoder 300 includes an entropy decoding unit 310, a prediction unit 320, an inverse quantization/transform unit 330, a reconstruction unit 340, an in-loop filtering unit 350, and a decoded picture buffer 360. It should be noted that, the video decoder 300 may include more, fewer, or different functional components.

The video decoder 300 may receive a bitstream. The entropy decoding unit 310 may parse the bitstream to extract a syntax element from the bitstream. As part of parsing of the bitstream, the entropy decoding unit 310 may parse an entropy encoded syntax element in the bitstream. The prediction unit 320, the inverse quantization/transform unit 330, the reconstruction unit 340, and the in-loop filtering unit 350 may decode video data based on the syntax element extracted from the bitstream, that is, generate decoded video data.

In some embodiments, the prediction unit 320 includes an intra prediction unit 322 and an inter prediction unit 321.

The intra prediction unit 322 may perform intra prediction to generate a predicted block of a PU. The intra prediction unit 322 may generate the predicted block of the PU based on a pixel block of a spatially adjacent PU by using an intra prediction mode. The intra prediction unit 322 may also determine an intra prediction mode of the PU based on one or more syntax elements parsed from the bitstream.

The inter prediction unit 321 may construct a first reference picture list (list 0) and a second reference picture list (list 1) based on the syntax element parsed from the bitstream. In addition, if inter prediction encoding is used for the PU, the entropy decoding unit 310 may parse motion information of the PU. The inter prediction unit 321 may determine one or more reference blocks of the PU based on the motion information of the PU. The inter prediction unit 321 may generate a predicted block of the PU based on the one or more reference blocks of the PU.

The inverse quantization/transform unit 330 may perform inverse quantization (that is, de-quantization) on a transform coefficient associated with the TU. The inverse quantization/transform unit 330 may determine a degree of quantization by using a QP value associated with a CU to which the TU belongs.

After the transform coefficient is inverse-quantized, the inverse quantization/transform unit 330 may apply one or more inverse transforms to the inverse-quantized transform coefficient to generate a residual block associated with the TU.

The reconstruction unit 340 reconstructs the pixel block of the CU by using the residual block associated with the TU of the CU and the predicted block of the PU of the CU. For example, the reconstruction unit 340 may add a sample of the residual block to a corresponding sample of the predicted block to reconstruct the pixel block of the CU, to obtain a reconstructed picture block.

The in-loop filtering unit 350 may perform a deblocking filtering operation to reduce block artifacts of the pixel block associated with the CU.

The video decoder 300 may store a reconstructed picture of the CU in the decoded picture buffer 360. The video decoder 300 may use the reconstructed picture in the decoded picture buffer 360 as a reference picture for subsequent prediction, or transmit the reconstructed picture to a display apparatus for display.

A basic process of video coding is as follows: at an encoding end, one frame of picture is partitioned into blocks. For a current block, the prediction unit 210 generates a predicted block of the current block through intra prediction or inter prediction. The residual unit 220 may calculate a residual block based on the predicted block and an original block of the current block, that is, a difference between the predicted block and the original block of the current block. The residual block may also be referred to as residual information. The residual block is subjected to procedures such as transform and quantization performed by the transform/quantization unit 230, which may remove information imperceptible to human eyes, to eliminate visual redundancy. Optionally, the residual block not subjected to transform and quantization by the transform/quantization unit 230 may be referred to as a time-domain residual block, and the time-domain residual block subjected to transform and quantization by the transform/quantization unit 230 may be referred to as a frequency residual block or a frequency-domain residual block. The entropy encoding unit 280 receives the quantized transform coefficient output by the transform/quantization unit 230, and may perform entropy encoding on the quantized transform coefficient to output a bitstream. For example, the entropy encoding unit 280 may eliminate character redundancy based on a target context model and probability information of a binary bitstream.

At a decoding end, the entropy decoding unit 310 may parse the bitstream to obtain prediction information of the current block, a quantized coefficient matrix, and the like; and the prediction unit 320 may perform intra prediction or inter prediction on the current block based on the prediction information to generate a predicted block of the current block. The inverse quantization/transform unit 330 performs inverse quantization and inverse transform on the quantized coefficient matrix obtained from the bitstream, to generate a residual block. The reconstruction unit 340 adds the predicted block and the residual block to obtain a reconstructed block. Reconstructed blocks form a reconstructed picture, and the in-loop filtering unit 350 performs in-loop filtering on the reconstructed picture on a picture basis or on a block basis to obtain a decoded picture. The encoding end is also required to perform similar operations as the decoding end to obtain the decoded picture. The decoded picture may also be referred to as a reconstructed picture. The reconstructed picture may serve as a reference frame for inter prediction of subsequent frames.

It should be noted that block partitioning information determined by the encoding end, and mode information or parameter information such as prediction, transform, quantization, entropy encoding, and in-loop filtering, are carried in the bitstream when necessary. The decoding end determines the same block partitioning information and mode information or parameter information such as prediction, transform, quantization, entropy encoding, and in-loop filtering as the encoding end by parsing the bitstream or analyzing existing information, thereby ensuring that the decoded picture obtained at the encoding end is the same as the decoded picture obtained at the decoding end.

The foregoing describes basic processes of the video encoder and the video decoder under a block-based hybrid encoding framework. With development of technologies, some modules or steps of the framework or processes may be optimized. This application is applicable to the basic processes of the video encoder and the video decoder under the block-based hybrid encoding framework, but is not limited to the framework and processes.

In embodiments of this application, a current block (current block) may be a current coding unit (CU), a current prediction unit (PU), or the like. For the purpose of parallel processing, a picture may be partitioned into slices or the like. Slices within one picture may be processed in parallel, that is, there is no data dependency between the slices. The term “frame” is a commonly used expression and may generally be understood as a picture. In this application, the frame may alternatively be replaced with a picture or a slice.

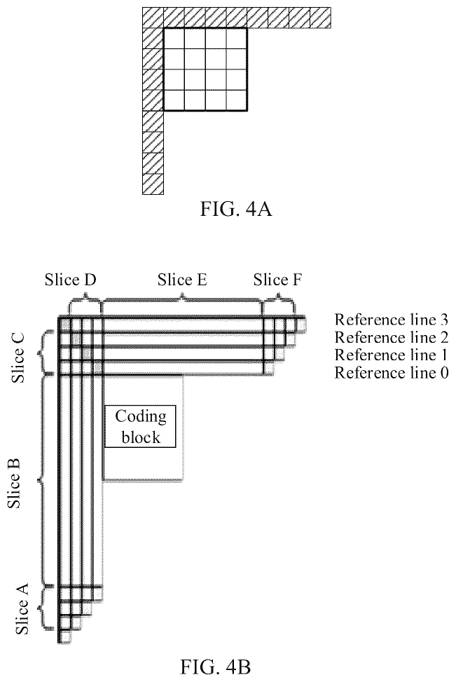

In intra prediction, various angular modes and non-angular modes are generally used to predict a current coding block to obtain a predicted block. Based on rate-distortion information calculated from the predicted block and an original block, an optimal prediction mode for the current coding unit is selected, and the prediction mode is transmitted to the decoding end via a bitstream. The decoding end parses the prediction mode, performs prediction to obtain a predicted picture of the current decoding block, and adds the predicted picture and residual pixels transmitted via the bitstream, to obtain the reconstructed picture. According to an intra prediction method, a current block is predicted by using an encoded and decoded reconstructed pixel surrounding the current block as a reference pixel. FIG. 4A is a schematic diagram of intra prediction. As shown in FIG. 4A, the current block has a size of 4×4. A row of pixels to the left of the current block and a column of pixels above the current block serve as reference pixels of the current block, and the current block is predicted through intra prediction using these reference pixels. These reference pixels may be all available, that is, all of them have already been encoded and decoded. Alternatively, some of these reference pixels may be unavailable. For example, if the current block is on the leftmost side of the frame, reference pixels to the left of the current block are unavailable. Alternatively, during encoding or decoding of the current block, if a part to the lower left of the current block is not encoded and decoded, a reference pixel to the lower left of the current block is also unavailable. In a case in which reference pixels are unavailable, available reference pixels or some values or methods may be used for filling, or no filling is performed.

FIG. 4B is a schematic diagram of intra prediction. As shown in FIG. 4B, in a multiple reference line intra prediction method (Multiple reference line, MRL), more reference pixels may be used to improve coding efficiency. For example, four reference rows/columns may be used as reference pixels of the current block.

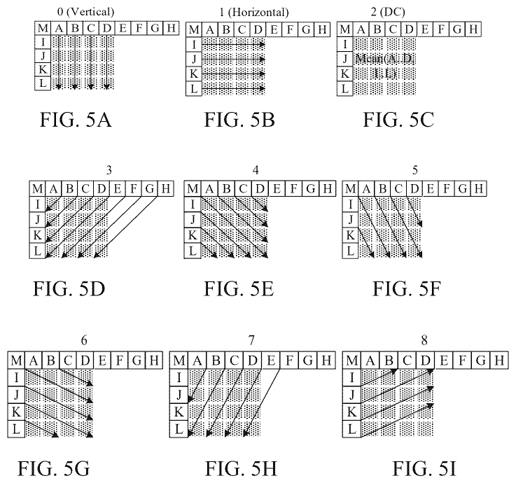

Further, there are a plurality of prediction modes for intra prediction. FIG. 5A to FIG. 5I are schematic diagrams of intra prediction. As shown in FIG. 5A to FIG. 5I, in H.264, there may mainly be nine modes for performing intra prediction on a 4×4 block. As shown in FIG. 5A, in a mode 0, pixels above the current block are copied in a vertical direction to the current block as predicted values. As shown in FIG. 5B, in a mode 1, left reference pixels are copied in a horizontal direction to the current block as predicted values. As shown in FIG. 5C, in a mode 2, that is, in a direct current DC mode, an average value of eight points A to D and I to L is used as a predicted value of all points. As shown in FIG. 5D to 5I, in each of modes 3 to 8, reference pixels are copied to corresponding locations of the current block according to a specific angle. Since some locations within the current block do not exactly correspond to reference pixels, it may be necessary to use a weighted average value of the reference pixels, that is, interpolated sub-pixels of the reference pixels.

In the video encoding field, Component is a technical term. Generally, it refers to three components Y, Cb, and Cr (or Y, U, and V), where Y denotes luma information, and Cb and Cr denote chroma information.

In H.266, before prediction encoding is performed on a chroma component of a CU, a luma component has already been encoded and a reconstructed value of the luma component has already been obtained. To remove redundancy between different color channels, a cross component intra prediction mode was proposed. The idea is to use the reconstructed luma block to predict a chroma block currently to be predicted. During prediction, a linear or nonlinear relationship between luma and chroma is required to be constructed based on reconstructed luma and chroma pixel values.

In some embodiments, cross component intra prediction modes include but are not limited to the following: cross component linear model prediction (CCLM for short), a convolutional cross component model (CCCM for short), a gradient linear model (GLM for short), and a cross component merge mode (CCMerge for short).

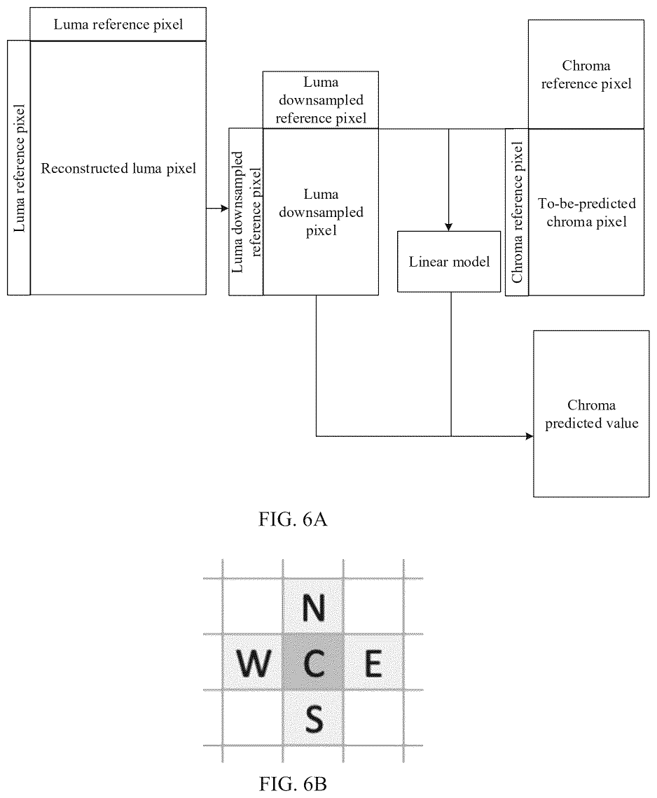

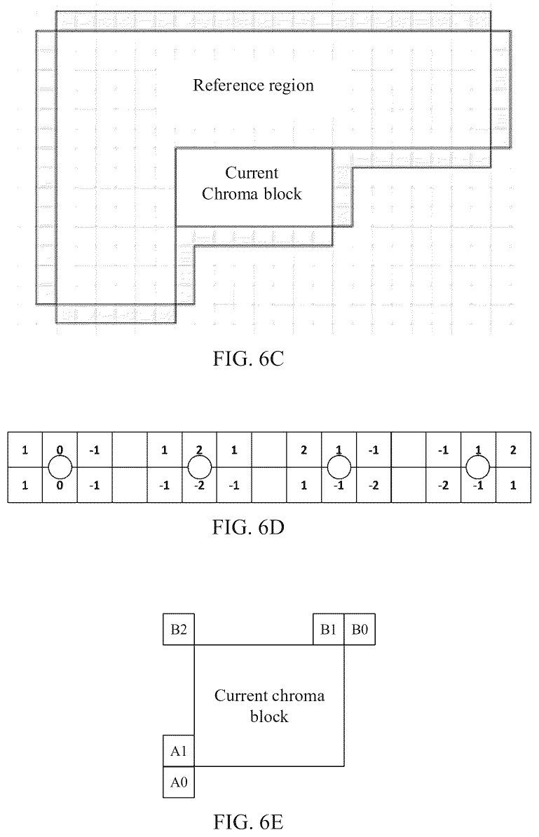

CCLM refers to calculating a chroma predicted pixel value of a to-be-predicted pixel based on a luma reconstructed value of the to-be-predicted pixel based on a linear relationship between a luma reconstructed value and a chroma reconstructed value of a reference pixel. For example, as shown in FIG. 6A, for the YUV420 format, a luma component is required to be downsampled to maintain the same spatial resolution as a chroma component. Then, a linear model parameter is calculated based on luma and chroma of a reference pixel. Next, a chroma predicted value is calculated based on a luma reconstructed value.

For example, a linear model may be in a slope-intercept form:

$$C ( x , y ) = αX L ( x , y ) + β \qquad ( 1 )$$

C and L denote a chroma pixel value and a luma pixel value, respectively. α and β denote two model parameters, which may be obtained by using a least squares method.

The idea of CCCM is similar to that of the CCLM technology, and CCCM also refers to a process of predicting a chroma pixel by using a reconstructed pixel of a luma component. However, CCCM no longer derives simple α and β; instead, it derives a set of convolution filter coefficients. CCCM also allows to derive two sets of convolution filter coefficients for one block. Similarly, which set of convolution filter coefficients is to be used is controlled by a Threshold (threshold).

In an example, a convolution filter used in CCCM is a 7-tap filter, consisting of a 5-tap cross-shaped filter, a nonlinear term, and a bias term. As shown in FIG. 6B, input of the 5-tap cross-shaped filter includes a middle (Center, C) luma sample (which is a downsampled luma sample at a location corresponding to a current chroma predicted location), an upper (Above/North, N) luma sample, a lower (Below/South, S) luma sample, a left (Left/West, W) luma sample, and a right (Right/East, E) luma sample.

The nonlinear term P is determined based on the center luma input sample C and bit depth bitDepth of a pixel value of a current predicted block. For example, the nonlinear term P is determined according to the following formula (2):

$$P = ( C \times C + ( 1 ≪ ( bitDepth - 1 ) ) ) ≫ bitDepth \qquad ( 2 )$$

in which, C denotes the luma input sample at the center location in FIG. 6B.

For example, if the bit depth bitDepth of the pixel value of the current predicted block is equal to 10 bits, the nonlinear term P is determined according to the following formula (3):

$$P = ( C \times C + 5 \; 12 ) ≫ 10 \qquad ( 3 )$$

The bias term B in CCCM is set to (1<< (bitDepth−1)). For example, if the pixel precision of the current predicted block is 10 bits, B=512.

In CCCM, the predicted value is determined based on an adaptively obtained 7-tap filter coefficient {c₀, . . . , c₆} and the input sample. For example, a predicted value may be determined according to the following formula (4):

$$predChromaVal = {c}_{0} C + {c}_{1} N + {c}_{2} S + {c}_{3} E + {c}_{4} W + {c}_{5} P + {c}_{6} B \qquad ( 4 )$$

In which, predChromaVal denotes a chroma predicted value of the current predicted block, CNSEW denotes the luma input sample of the cross-shaped filter shown in FIG. 6B, P denotes the nonlinear term, and B denotes the bias term.

The filter coefficient {c₀, . . . , c₆} is calculated by minimizing a mean square error MSE between total chroma predicted values and reconstructed values of a reconstructed region.

For example, the filter coefficient {c₀, . . . , c₆} is calculated according to the following formula (5):

$$MSE = E [ {( p r e d C [ i ] - r e c C [ i ] )}^{2} ] = E [ {( {\sum }_{n = 0}^{6} {c}_{n} ▯ refL [ n ] - recC [ i ] )}^{2} ] \qquad ( 5 )$$

In which, predC denotes the chroma predicted value, recC denotes the chroma reconstructed value, and refL denotes the luma reconstructed value.

In an example, as shown in FIG. 6C, a reconstructed region of a current chroma block is composed of 6 rows and 6 columns of reconstructed pixel values surrounding the current chroma block. If there is a location in the reconstructed region that has not yet been reconstructed, a value at this location is filled with a reconstructed value. As shown in FIG. 6C, a reference region is extended rightward by a width of the current chroma block and downward by a height of the current chroma block. Extended gray regions in FIG. 6C are used for edge sampling of a square spatial filter, and values within the gray region are filled by copying adjacent reconstructed pixels.

A calculation process of minimizing the mean square error is as follows.

In step 1, an auto-correlation matrix of a luma input sample and a cross-correlation vector between the luma input sample and a chroma output sample are obtained.

In step 2, the auto-correlation matrix is decomposed via LDL, and the final filter coefficient is obtained by solving through back substitution.

For example, the filter coefficient {c₀, . . . , c₆} is determined according to the following formula (6):

$$[ \begin{matrix}{\sum }_{\text{?}} ( refL [ i ] [ 0 ] \cdot refL [ i ] [ 0 ] ) & {\sum }_{\text{?}} ( refL [ \text{?} ] [ \text{?} ] \cdot refL [ i ] [ 0 ] ) & … & {\sum }_{\text{?}} ( refL [ i ] [ 6 ] \cdot refL [ i ] [ 0 ] ) \\ {\sum }_{\text{?}} ( refL [ i ] [ 0 ] \cdot refL [ i ] [ \text{?} ] ) & {\sum }_{\text{?}} ( refL [ \text{?} ] [ \text{?} ] \cdot refL [ \text{?} ] [ \text{?} ] ) & … & {\sum }_{\text{?}} ( refL [ i ] [ 6 ] \cdot refL [ \text{?} ] [ \text{?} ] ) \\ ⋮ & ⋮ & ⋱ & ⋮ \\ {\sum }_{\text{?}} ( refL [ i ] [ 0 ] \cdot refL [ i ] [ 6 ] ) & {\sum }_{\text{?}} ( refL [ i ] [ \text{?} ] \cdot refL [ i ] [ 6 ] ) & … & {\sum }_{\text{?}} ( refL [ i ] [ 6 ] \cdot refL [ i ] [ 6 ] )\end{matrix} ] \cdot [ \begin{matrix}{c}_{0} \\ {c}_{1} \\ ⋮ \\ c \text{?}\end{matrix} ] = [ \begin{matrix}{\sum }_{\text{?}} ( refC [ i ] \cdot refL [ i ] [ 0 ] ) \\ {\sum }_{\text{?}} ( refC [ i ] \cdot refL [ i ] [ \text{?} ] ) \\ ⋮ \\ {\sum }_{\text{?}} ( refC [ i ] \cdot refL [ \text{?} ] [ \text{?} ] )\end{matrix} ] \qquad ( 6 )$$

$$\text{?} \text{indicates text missing or illegible when filed}$$

In which,

$$[ \begin{matrix}{\sum }_{\text{?}} ( refL [ i ] [ 0 ] \cdot refL [ i ] [ 0 ] ) & {\sum }_{\text{?}} ( refL [ \text{?} ] [ \text{?} ] \cdot refL [ i ] [ 0 ] ) & … & {\sum }_{\text{?}} ( refL [ i ] [ 6 ] \cdot refL [ i ] [ 0 ] ) \\ {\sum }_{\text{?}} ( refL [ i ] [ 0 ] \cdot refL [ i ] [ \text{?} ] ) & {\sum }_{\text{?}} ( refL [ \text{?} ] [ \text{?} ] \cdot refL [ \text{?} ] [ \text{?} ] ) & … & {\sum }_{\text{?}} ( refL [ i ] [ 6 ] \cdot refL [ \text{?} ] [ \text{?} ] ) \\ ⋮ & ⋮ & ⋱ & ⋮ \\ {\sum }_{\text{?}} ( refL [ i ] [ 0 ] \cdot refL [ i ] [ 6 ] ) & {\sum }_{\text{?}} ( refL [ i ] [ \text{?} ] \cdot refL [ i ] [ 6 ] ) & … & {\sum }_{\text{?}} ( refL [ i ] [ 6 ] \cdot refL [ i ] [ 6 ] )\end{matrix} ]$$

$$\text{?} \text{indicates text missing or illegible when filed}$$

denotes the auto-correlation matrix of a luma input sample, and

$$[ \begin{matrix}{\sum }_{\text{?}} ( refC [ i ] \cdot refL [ i ] [ 0 ] ) \\ {\sum }_{\text{?}} ( refC [ i ] \cdot refL [ i ] [ \text{?} ] ) \\ ⋮ \\ {\sum }_{\text{?}} ( refC [ i ] \cdot refL [ \text{?} ] [ \text{?} ] )\end{matrix} ]$$

$$\text{?} \text{indicates text missing or illegible when filed}$$

denotes the cross-correlation vector of a luma input sample and a chroma output sample.

During calculation of the auto-correlation matrix, since a value of the luma input sample used is relatively large, higher precision is required when calculating a convolution filter coefficient. Therefore, in the CCCM, values of the input luma sample and the output chroma sample are required to be subtracted by corresponding offsets offsetLuma, offsetCb, and offsetCr. A luma reconstructed value and a chroma predicted value at a location outside the upper-left corner of the current predicted block are used as offsets. Accordingly, the CCCM input is as follows:

$$\begin{matrix}C ' = C - offsetLuma \\ N ' = N - offsetLuma \\ S ' = S - offsetLuma \\ E ' = E - offsetLuma \\ W ' = W - offsetLuma \\ P ' = nonLinear ( C ' ) \\ B = midValue = 1 << ( bitDepth - 1 )\end{matrix}$$

The chroma predicted value is calculated according to the following formula (7):

$$predChromaVal = {c}_{0} C ' + {c}_{1} N ' + {c}_{2} S ' + {c}_{3} E ' + {c}_{4} W ' + {c}_{5} P ' + {c}_{6} B + offsetChroma \qquad ( 7 )$$

In which, offsetChroma is an offset of each of a Cb component and a Cr component.

CCCM also allows to configure two sets of filter coefficients for one block. Similar to MMLM, for example, use of a specific set of coefficients is controlled by a Threshold.

Since the CCCM filter coefficients c0 to c6, the potential Threshold, and the second set of parameters are derived, it is unnecessary to parse them from a bitstream.

GLM is an intra-frame chroma cross-component prediction tool used for the YUV 4:2:0 format. In the ECM reference software (based on the VTM-10.0 reference software, integrating various new tools to further exploit coding performance), GLM includes both a two-parameter model and a three-parameter model.

Compared with CCLM, GLM derives a linear model by using a gradient values of a luma reconstructed samples and a chroma reconstructed sample.

For example, for the two-parameter GLM model, a chroma predicted value C is calculated according to the following formula (8):

$$C = α \cdot G + β \qquad ( 8 )$$

In which, G denotes a gradient value of a luma sample corresponding to a current location. A calculation method of α and β is the same as that in CCLM.

For example, for the three-parameter GLM model, a chroma predicted value C is calculated from a luma sample corresponding to a current location and a gradient value of a corresponding luma sample according to the following formula (9):

$$C = {α}_{0} \cdot G + {α}_{1} \cdot L + {α}_{2} \cdot β \qquad ( 9 )$$

A calculation method of α₀, α₁, and α₂ is the same as that in CCCM.

For example, β=(1<< (bitDepth−1)). For content about a predicted block with a pixel precision of 10 bits, β=512.

In an example, a gradient in GLM is obtained by using one of four sober operators shown in FIG. 6D. Specifically, which sober operator is to be used for obtaining a gradient value is determined using a flag bit obtained by parsing a bitstream.

Since the parameters in the GLM are also derived, it is unnecessary to parse them from a bitstream.

In CCMerge, cross-component prediction models at surrounding locations adjacent or non-adjacent to the current chroma block are inherited and applied to prediction of the current block. In CCMerge, a list having a length of N (N=6) is constructed. Cross-component models inherited from surrounding blocks are stored in the list, with no repeated entries. These cross-component models may be one or more models of CCLM, MMLM, CCCM, and GLM. In a case that surrounding models are insufficient to fill the CCMerge list, remaining entries in the list are filled with a default model.

In CCMerge, to obtain cross-component models from surrounding adjacent locations, as shown in FIG. 6E, locations B1→A1→B0→A0→B2 are sequentially accessed.

In CCMerge, cross-component models from non-adjacent locations may be further obtained. The concept of non-adjacent locations has also been used in inter-frame merge. These locations include non-adjacent locations such as an upper location, an upper-left location, an upper-right location, a left location, and a lower-left location of the current chroma block.

In a case that a quantity of cross-component models obtained from adjacent and non-adjacent locations is less than N, remaining entries of the list are filled with CCLM models having default slopes. The default slopes a are sequentially {0, ⅛, −⅛, 2/8, − 2/8, ⅜}, and β is calculated according to the calculation method described in the CCLM section.

A block-level flag bit is encoded and decoded to indicate whether the CCMerge mode is selected. In a case that the CCMerge mode is selected, it is further necessary to decode to determine which model in the CCMerge list has been selected. A model index is encoded and decoded using truncated unary coding.

It may be learned from the foregoing description that, in embodiments of this application, a cross component intra prediction mode may be used to obtain a predicted value of a current chroma block. However, a predicted value of a chroma block determined based on a current cross component intra prediction mode may be inaccurate.

In embodiments of this application, a predicted value of a current chroma block is limited. Specifically, a prediction mode of a current chroma block is determined; in a case that the prediction mode is a cross component intra prediction mode, a limit range of a predicted value of the current chroma block is determined, where the limit range includes at least one of a maximum limit value or a minimum limit value of the predicted value; next, a first predicted value of the current chroma block is determined based on the cross component intra prediction mode; and a second predicted value of the current chroma block is determined based on the first predicted value and the limit range. That is, in embodiments of this application, in a case that the cross component intra prediction mode is used for the current chroma block, the first predicted value determined based on the cross component intra prediction mode is limited, thereby preventing the predicted value of the current chroma block from being excessively large or small, thus improving prediction accuracy of the current chroma block and enhancing video coding performance.

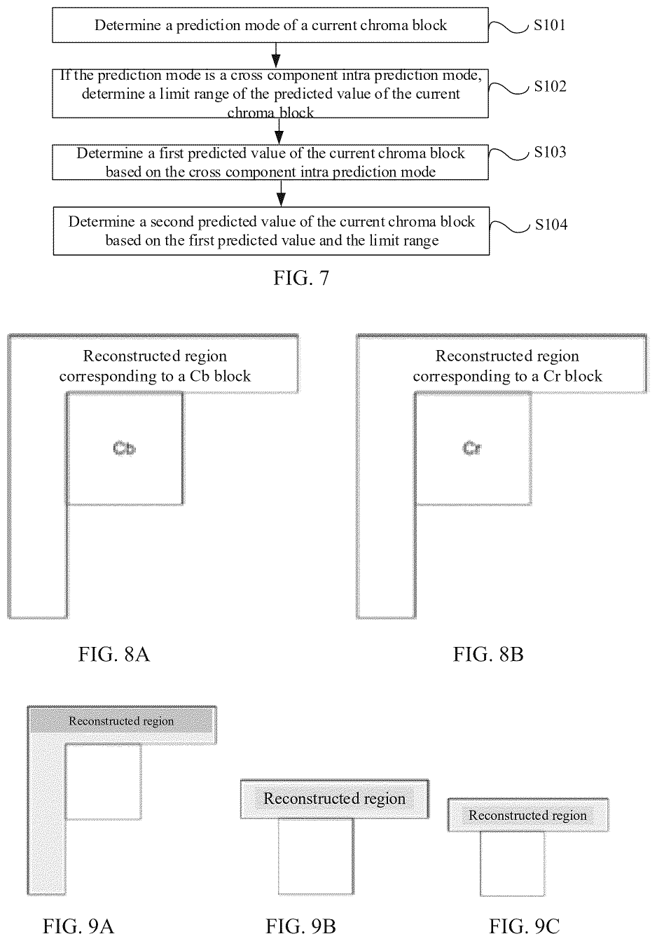

With reference to FIG. 7, the following describes, by using the decoding end as an example, a video decoding method provided in embodiments of this application.

FIG. 7 is a schematic flowchart of a video decoding method according to an embodiment of this application. This embodiment of this application is applied to the video decoder shown in FIG. 1 and FIG. 3. As shown in FIG. 7, the method in embodiments of this application includes the following steps S101 to S104.

In S101, a prediction mode of a current chroma block is determined.

In embodiments of this application, when decoding the current block, the decoding end first performs prediction decoding on a luma component of the current block, to obtain a luma reconstructed value of the current block. Next, prediction decoding is performed on a chroma component of the current block.

In embodiments of this application, the chroma component of the current block is referred to as the current chroma block.

Before prediction decoding is performed on the current chroma block, a prediction mode of the current chroma block is first determined.

In embodiments of this application, a specific manner of determining the prediction mode of the current chroma block is not limited.

In an example, a default prediction mode is determined as the prediction mode of the current chroma block. That is, in embodiments of this application, both the encoding end and the decoding end predict the current chroma block by using the default prediction mode.

In an example, the encoding end determines, from a plurality of candidate prediction modes, a prediction mode having the minimum cost as the prediction mode of the current chroma block. In addition, the encoding end encodes indication information of the prediction mode into a bitstream, for example, encodes a mode index of the prediction mode into a bitstream. In this case, S101 includes the following step S101-A.

In S101-A, the decoding end obtains a prediction mode of the current chroma block by decoding a bitstream.

It may be learned from the foregoing description that, the cross component intra prediction mode includes modes such as CCLM, CCCM, GLM, and CCMerge. In the CCMerge mode, the prediction mode of the current chroma block is determined by constructing a list. Based on this, in some cases, the decoding end cannot directly determine the prediction mode of the current chroma block by decoding the bitstream. For example, if the CCMerge mode is obtained by decoding the bitstream, the decoding end is further required to construct a cross-component prediction mode list, and determine a predicted value of the current chroma block from the list. Therefore, in embodiments of this application, for ease of description, the prediction mode obtained by decoding the bitstream is referred to as a first prediction mode. In this case, S101-A includes the following steps.

In S101-A1, the bitstream is decoded to obtain a first prediction mode.

In S101-A2, the prediction mode of the current chroma block is determined based on the first prediction mode.

In embodiments of this application, the prediction mode written into the bitstream by the encoding end is referred to as the first prediction mode. In this way, the decoding end may directly obtain the first prediction mode by decoding the bitstream. For example, the decoding end decodes the bitstream to obtain a prediction mode index, and determines the first prediction mode based on the prediction mode index. Alternatively, the decoding end decodes the bitstream to obtain an enable flag of at least one prediction mode, and then determine the first prediction mode based on the enable flag of the at least one prediction mode. For example, in a case that an enable flag of the CCCM mode that is obtained by decoding the bitstream by the decoding end is equal to 1, it indicates that the CCCM mode is used. In this case, the first prediction mode is determined as the CCCM mode. Alternatively, in a case that an enable flag of the CCMerge mode that is obtained by decoding the bitstream by the decoding end is equal to 1, it indicates that the CCMerge mode is used. In this case, the first prediction mode is determined as the CCMerge mode.

After obtaining the first prediction mode by decoding the bitstream, the decoding end determines the prediction mode of the current chroma block based on the first prediction mode.

The operation of determining the prediction mode of the current chroma block based on the first prediction mode includes at least the following two cases.

Case 1: If the first prediction mode is the CCCM mode or the GLM mode, the decoding end directly determines the CCCM mode or the GLM mode as the prediction mode of the current chroma block.

Case 2: If the first prediction mode is a cross component merge mode, S101-A2 includes the following steps:

In S101-A21, a cross component prediction mode list is constructed by inheriting a cross component intra prediction mode of a chroma block surrounding the current chroma block that is adjacent and/or non-adjacent to the current chroma block.

In S101-A22, the prediction mode of the current chroma block is determined based on the cross component prediction mode list.

In Case 2, if the first prediction mode obtained by decoding the bitstream by the decoding end is the CCMerge mode, the decoding end constructs a cross component prediction mode list having a length of N.

For example, a process in which the decoding end constructs the cross component prediction mode list may include the following steps.

First, the decoding end obtains a cross component intra prediction mode of a chroma block at a surrounding location adjacent to the current chroma block. For example, as shown in FIG. 6E, the decoding end sequentially accesses the locations B1→A1→B0→A0→B2. If the cross component intra prediction mode is used for at least one of the chroma blocks at these locations, the cross component intra prediction mode of the at least one chroma block is stored in the cross component prediction mode list. For example, cross component intra prediction modes may be stored in the cross component prediction mode list in the same order as the access order of the locations.

In some embodiments, if the length of the cross component prediction mode list does not meet a preset length, that is, N, the decoding end may further obtain a cross component intra prediction mode of a chroma block at a location non-adjacent to the current chroma block. Non-adjacent locations include an upper location, an upper-left location, an upper-right location, a left location, and a lower-left location of the current chroma block.

In some embodiments, if the length of the cross component prediction mode list does not meet a preset length, namely, N, that is, if a quantity of cross component intra prediction modes obtained from locations adjacent and non-adjacent to the current chroma block does not meet N, remaining entries in the list are filled with the CCLM mode with a default slope.

After constructing the cross component prediction mode list according to the foregoing steps, the decoding end determines the prediction mode of the current chroma block based on the cross component prediction mode list.

In embodiments of this application, a specific manner of determining the prediction mode of the current chroma block based on the cross component prediction mode list is not limited.

In an example, the decoding end and the encoding end construct the cross component prediction mode list by using the same method, and one cross component intra prediction mode in the cross component prediction mode list is used by default as the prediction mode of the current chroma block. For example, the 1^{st} cross component intra prediction mode in the cross component prediction mode list is used by default as the prediction mode of the current chroma block. Alternatively, the 2^{nd} cross component intra prediction mode in the cross component prediction mode list is used by default as the prediction mode of the current chroma block.

In an example, the decoding end and the encoding end construct the cross component prediction mode list by using the same method. In addition, the encoding end writes, into a bitstream, a mode index of the cross component intra prediction mode selected from the cross component prediction mode list for the current chroma block. In this case, the decoding end decodes the bitstream to obtain the mode index, and then determines the prediction mode of the current chroma block from the cross component prediction mode list based on the mode index. For example, each mode in the cross component prediction mode list corresponds to one mode index. For example, ranking of the mode in the list is determined as a mode index of the mode. In this way, the decoding end determines that the mode corresponding to the mode index in the cross component prediction mode list is the prediction mode of the current chroma block.

After determining the prediction mode of the current chroma block according to the foregoing steps, the decoding end performs the following step S102.

In S102, if the prediction mode is a cross component intra prediction mode, a limit range of the predicted value of the current chroma block is determined.

The limit range includes at least one of a maximum limit value or a minimum limit value of the predicted value.

In embodiments of this application, to further improve prediction accuracy of the cross component intra prediction mode, in a case that the cross component intra prediction mode is used for the current chroma block, the limit range of the predicted value of the current chroma block is determined, so that the predicted value of the current chroma block is limited within the limit range, thereby preventing the predicted value of the current chroma block that is obtained by prediction from being excessively large or small due to prediction errors, thus further improving prediction accuracy of the chroma component.

It should be noted that, in embodiments of this application, a value range of the predicted value of the chroma component is limited. In some embodiments, a value range of a predicted value of the luma component and the like may also be limited.

In some embodiments, limiting the predicted value of the current chroma block may include: limiting a maximum value of the predicted value of the current chroma block, and recording the limit value as the maximum limit value of the predicted value. That is, the predicted value of the current chroma block is limited so as not to exceed the maximum limit value.

In some embodiments, limiting the predicted value of the current chroma block may include: limiting a minimum value of the predicted value of the current chroma block, and recording the limit value as the minimum limit value of the predicted value. That is, the predicted value of the current chroma block is limited so as not to be less than the minimum limit value.

In some embodiments, limiting the predicted value of the current chroma block may include: limiting both the maximum value and the minimum value of the predicted value of the current chroma block. That is, the predicted value of the current chroma block is limited so as not to be less than the minimum limit value, and the predicted value of the current chroma block is limited so as not to exceed the maximum limit value.

In some embodiments, a flag (that is, a first flag) is used to indicate whether the decoding end limits the predicted value of the current chroma block. In this case, before determining the limit range of the predicted value of the current chroma block, the decoding end is first required to determine a first flag corresponding to the current chroma block. The first flag is used to indicate whether to limit the predicted value of the current chroma block. In this way, the decoding end determines, based on the first flag, whether to limit a value range of the predicted value of the current chroma block.

For example, if the first flag indicates that the predicted value of the current chroma block is not to be limited, the decoding end skips the step of determining the limit range of the predicted value of the current chroma block.

For another example, if the first flag indicates that the predicted value of the current chroma block is to be limited, the decoding end determines the limit range of the predicted value of the current chroma block.

In embodiments of this application, a specific manner in which the decoding end determines the first flag corresponding to the current chroma block is not limited.

In some embodiments, if the first prediction mode obtained by decoding the bitstream by the decoding end is the CCMerge mode, the decoding end determines a cross component intra prediction mode of the current chroma block by inheriting a cross component intra prediction mode of a chroma block surrounding the current chroma block that is adjacent and/or non-adjacent to the current chroma block. For example, referring to the foregoing embodiment, if the decoding end inherits a cross component intra prediction mode of a chroma block 1, in this embodiment, the decoding end may further inherit a first flag of the chroma block 1. That is, if the first prediction mode is the CCMerge mode, the decoding end determines a chroma block corresponding to a prediction mode inherited by the current chroma block, and determines a first flag corresponding to the chroma block as the first flag corresponding to the current chroma block.

In some embodiments, the decoding end obtains the first flag by decoding the bitstream. That is, in this implementation, the encoding end writes the first flag corresponding to the current chroma block into the bitstream, and the decoding end decodes the bitstream to obtain the first flag corresponding to the current chroma block.

In embodiments of this application, a specific representation of the first flag is not limited, and the first flag may be understood as any information that may indicate whether to limit the predicted value of the current chroma block.

In an example, the first flag may be denoted as cross_component_clip_flag. In this way, different values are assigned to cross_component_clip_flag to indicate whether to limit the predicted value of the current chroma block. For example, if a value of cross_component_clip_flag is a first value, it indicates that the predicted value of the current chroma block is to be limited. If a value of cross_component_clip_flag is a second value, it indicates that the predicted value of the current chroma block is not to be limited.

Specific values of the first value and the second value are not limited in embodiments of this application.

For example, the first value is 1.

For example, the second value is 0.

In this embodiment, the decoding end determines the prediction mode of the current chroma block according to the foregoing steps. If it is determined that the prediction mode of the current chroma block is the cross component intra prediction mode (for example, the CCCM mode or the GLM mode), the decoding end determines the first flag corresponding to the current chroma block, and then determines whether to limit the predicted value of the current chroma block based on the first flag. Specifically, if a value of the first flag is the first value, it indicates that the predicted value of the current chroma block is to be limited. In this way, the decoding end determines the limit range of the predicted value of the current chroma block. If a value of the first flag is the second value, it indicates that the predicted value of the current chroma block is not to be limited. In this case, the decoding end skips the step of determining the limit range of the predicted value of the current chroma block, and directly uses a predicted value obtained based on the cross component intra prediction mode as the predicted value of the current chroma block.

In some embodiments, if the decoding end fails to decode the first flag when decoding the bitstream, that is, the first flag does not exist in the bitstream, a value of the first flag is set by default to the second value, indicating that the predicted value of the current chroma block is not to be limited.

For example, syntax elements included in the bitstream are shown in Table 1.

TABLE 1

```
coding_unit( x0, y0, cbWidth, cbHeight, cqtDepth, treeType, modeType ) {
  ... ... //Parse a syntax element related to the prediction mode
  if(pu.cccmFlag ∥ pu.glmFlag)
  cross_component_clip_flag
  ... ... //Parse other syntax elements
}
```

The cross component intra prediction mode shown in Table 1 is the CCCM or GLM mode. However, in embodiments of this application, in addition to the CCCM and GLM modes, the cross component intra prediction mode includes other cross component intra prediction modes, which is not limited in embodiments of this application. In which, pu.cccmFlag is a flag indicating whether to use the CCCM mode for the current chroma block, and pu.glmFlag is a flag indicating whether to use the GLM mode for the current chroma block. cross_component_clip_flag is the first flag.

As shown in Table 1, the decoding end first decodes the bitstream to obtain related information such as a size and bit depth of the current chroma block. Next, the decoding end decodes the syntax element pu.cccmFlag∥pu.glmFlag related to the prediction mode. If the CCCM or GLM mode is used for the current chroma block, that is, the cross component intra prediction mode is used for the current chroma block, the bitstream is decoded to obtain the first flag cross_component_clip_flag. The cross_component_clip_flag is a binary flag. In a case that the flag bit is set to the first value (for example, 1), it indicates that a range of the predicted value of the current chroma block is required to be limited. In a case that the flag bit is set to the second value (for example, 0), it indicates that a range of the predicted value of the current chroma block is unnecessary to be limited.

In some embodiments, whether the decoding end limits the predicted value of the current chroma block is indicated by determining whether the current chroma block meets a preset condition. That is, in embodiments of this application, ranges of predicted values of some chroma blocks are limited, but ranges of predicted values of some chroma blocks are not limited. In this case, before determining the limit range of the predicted value of the current chroma block, the decoding end is first required to determine whether the current chroma block meets the preset condition.

For example, if the current chroma block does not meet the preset condition, the decoding end skips the step of determining the limit range of the predicted value of the current chroma block.

For another example, if the current chroma block meets the preset condition, the decoding end determines the limit range of the predicted value of the current chroma block.

In embodiments of this application, the preset condition is not limited, and may be specifically set according to actual requirements.

In some embodiments, the preset condition includes at least one of the following:
the current chroma block is not a first-row chroma block of a current CTU;
a size of the current chroma block meets a preset size; or
a shape of the current chroma block meets a preset shape.

That is, in embodiments of this application, the preset condition may include any one of the foregoing three conditions, or any two of the foregoing three conditions, or all of the foregoing three conditions.

In an example, both the CCCM and GLM modes require reconstructed pixel values from a plurality of rows and a plurality of columns to derive model parameters. Therefore, in the ECM reference software, to reduce storage of row buffers across CTUs, the use of the CCCM and GLM modes is limited for a block located at an upper boundary of a CTU. Accordingly, in embodiments of this application, a method for determining the limit range of the predicted value of the current chroma block is also limited. That is, in a case that the current chroma block is the first-row chroma block of the current CTU, the step of determining the limit range of the predicted value of the current chroma block is skipped.

In an example, the size of the current chroma block meeting the preset size may refer to that at least one of a length or a width of the current chroma block meets a preset value, for example, the length of the current chroma block is less than or equal to a preset length and the width is less than or equal to a preset width. For another example, the length of the current chroma block is less than or equal to a preset length. For another example, the width of the current chroma block is less than or equal to a preset width.

In an example, the size of the current chroma block meeting the preset size may refer to that a quantity of pixels included in the current chroma block meets a preset quantity.

In an example, the shape of the current chroma block meeting the preset shape may refer to that at least one of a length-to-width ratio or a width-to-length ratio of the current chroma block meets a preset ratio. For example, the length-to-width ratio of the current chroma block is less than or equal to a first ratio, and the width-to-length ratio is less than or equal to a second ratio. For another example, the length-to-width ratio of the current chroma block is less than or equal to a first ratio. For another example, the width-to-length ratio is less than or equal to a second ratio.

It may be learned from the foregoing description that, in embodiments of this application, a manner of determining whether to limit the predicted value of the current chroma block includes at least the following several examples.

Example 1: The decoding end limits the predicted value of the current chroma block by default. That is, when determining that the prediction mode of the current chroma block is the cross component intra prediction mode, the decoding end determines the limit range of the predicted value of the current chroma block.

Example 2: Whether to limit the predicted value of the current chroma block is indicated using the first flag. In this case, when determining that the prediction mode of the current chroma block is the cross component intra prediction mode, the decoding end is also required to determine the first flag corresponding to the current chroma block, and further determine, based on the first flag, whether to limit the predicted value of the current chroma block. For example, if the first flag indicates that the predicted value of the current chroma block is to be limited, the decoding end determines the limit range of the predicted value of the current chroma block. For another example, if the first flag indicates that the predicted value of the current chroma block is not to be limited, the decoding end skips the step of determining the limit range of the predicted value of the current chroma block.

Example 3: Whether to limit the predicted value of the current chroma block is determined by determining whether the current chroma block meets the preset condition. That is, when determining that the prediction mode of the current chroma block is the cross component intra prediction mode, the decoding end determines whether the current chroma block meets the preset condition. If the current chroma block meets the preset condition, the decoding end determines the limit range of the predicted value of the current chroma block. For another example, if the current chroma block does not meet the preset condition, the decoding end skips the step of determining the limit range of the predicted value of the current chroma block.

Example 4: Whether to limit the predicted value of the current chroma block is determined based on the first flag and the preset condition. That is, in Example 4, if the first flag corresponding to the current chroma block indicates that the predicted value of the current chroma block is to be limited, and the current chroma block meets the preset condition, the decoding end determines the limit range of the predicted value of the current chroma block. If the first flag of the current chroma block indicates that the predicted value of the current chroma block is not to be limited, and/or the current chroma block does not meet the preset condition, the decoding end skips the step of determining the limit range of the predicted value of the current chroma block. In Example 4, the decoding end may first determine whether the current chroma block meets the preset condition. If the current chroma block does not meet the preset condition, the decoding end does not decode the first flag, and directly skips the step of determining the limit range of the predicted value of the current chroma block, thereby avoiding decoding unnecessary information, thus saving decoding resources. If it is determined that the current chroma block meets the preset condition, the decoding end decodes the bitstream to obtain the first flag. If the first flag indicates that the predicted value of the current chroma block is to be limited, the decoding end determines the limit range of the predicted value of the current chroma block. If the first flag indicates that the predicted value of the current chroma block is not to be limited, the decoding end skips the step of determining the limit range of the predicted value of the current chroma block.

The following describes a specific process in which the decoding end determines the limit range of the predicted value of the current chroma block.

In embodiments of this application, the decoding end determines the limit range of the predicted value of the current chroma block by the following manners.

Manner 1: The limit range of the predicted value of the current chroma block is a preset value. That is, at least one of the maximum limit value or the minimum limit value of the predicted value of the current chroma block is a preset value. The preset value may be an empirical value or an experimental value, which is not limited in embodiments of this application.

Manner 2: If the first prediction mode obtained by decoding the bitstream by the decoding end is the CCMerge mode, the decoding end inherits a cross component intra prediction mode of a chroma block surrounding the current chroma block that is adjacent and/or non-adjacent to the current chroma block. For example, referring to the foregoing embodiment, the decoding end inherits the cross component intra prediction mode of the chroma block 1. In this embodiment, the decoding end may further inherit a limit range of a predicted value of the chroma block 1. That is, if the first prediction mode is the CCMerge mode, the decoding end determines a chroma block corresponding to a prediction mode inherited by the current chroma block, and determines a limit range of a predicted value of the chroma block as the limit range of the predicted value of the current chroma block.

Manner 3: a chroma value of the current chroma block is correlated with a chroma block within a region surrounding the current chroma block; based on this, S102 includes the following step S102-A.

In S102-A, the limit range of the predicted value of the current chroma block is determined based on a chroma value of a surrounding reconstructed region of the current chroma block.

In embodiments of this application, the chroma component includes a first chroma component and a second chroma component. The first chroma component may be a U component or a Cb component, and the second chroma component may be a V component or a Cr component. In this way, the decoding end may determine a limit range of a predicted value of the current chroma block for each of the first chroma component and the second chroma component, based on a chroma value of the surrounding reconstructed region of the current chroma block for each of the first chroma component and the second chroma component.

In embodiments of this application, a specific manner in which the decoding end determines the limit range of the predicted value of the current chroma block for each of the first chroma component and the second chroma component based on the chroma value of the surrounding reconstructed region of the current chroma block for each of the first chroma component and the second chroma component is not limited.

In some embodiments, the decoding end determines a maximum limit value and/or a minimum limit value of the predicted value of the current chroma block based on a chroma value of the surrounding reconstructed region of the current chroma block. That is, the predicted value of the current chroma block for each of the first chroma component and the second chroma component is limited so as not to exceed the maximum limit value, and/or the predicted value of the current chroma block for each of the first chroma component and the second chroma component is limited so as not to be less than the minimum limit value. For example, a maximum chroma value of the surrounding reconstructed region of the current chroma block is used as the maximum limit value of the predicted value of the current chroma block. In this case, the maximum chroma value is the maximum of the chroma values for the first chroma component and the second chroma component. For another example, a minimum chroma value of the surrounding reconstructed region of the current chroma block is used as the minimum limit value of the predicted value of the current chroma block. In this case, the minimum limit value is the minimum of the chroma value of the surrounding reconstructed region for the first chroma component and the chroma value of the surrounding reconstructed region for the second chroma component.

In some embodiments, since a chroma value of each pixel in the surrounding reconstructed region of the current chroma block has been reconstructed, the decoding end may find a pixel 1 having the largest chroma value for the first chroma component or the second chroma component within the surrounding reconstructed region of the current chroma block, and further determine the chroma value of the pixel 1 as the limit range of the predicted value of the current chroma block. That is, the decoding end determines that the chroma value of the pixel 1 for the first chroma component is the maximum limit value of the current chroma block for the first chroma component, and determines that the chroma value of the pixel 1 for the second chroma component is the maximum limit value of the current chroma block for the second chroma component. Alternatively, the decoding end may find a pixel 2 having the smallest chroma value for the first chroma component or the second chroma component within the surrounding reconstructed region of the current chroma block, and further determine the chroma value of the pixel 2 as the limit range of the predicted value of the current chroma block. That is, the decoding end determines that the chroma value of the pixel 2 for the first chroma component is the minimum limit value of the current chroma block for the first chroma component, and determines that the chroma value of the pixel 2 for the second chroma component is the minimum limit value of the current chroma block for the second chroma component. In this case, each of the first chroma component and the second chroma component corresponds to one limit range.

In some embodiments, the decoding end determines a predicted value of the current chroma block for each of the first chroma component and the second chroma component. Accordingly, determining a limit range of the predicted value of the current chroma block for the first chroma component is independent of determining a limit range of the predicted value of the current chroma block for the second chroma component. A specific process of determining the limit range of the predicted value for the first chroma component is basically the same as a specific process of determining the limit range of the predicted value for the second chroma component. For ease of description, determining the limit range of the predicted value of the current chroma block for an i^{th} chroma component is used herein as an example for description. The i^{th} chroma component may be the first chroma component (a U component or a Cb component), or may be the second chroma component (a V component or a Cr component). Based on this, S102-A includes the following step S102-A1.

In S102-A1, a limit range of a predicted value of the current chroma block for an i^{th} chroma component is determined based on a chroma value of the surrounding reconstructed region for the i^{th} chroma component.

In embodiments of this application, the decoding end determines the limit range of the predicted value of the current chroma block for the i^{th} chroma component based on the chroma value of the surrounding reconstructed region of the current chroma block for the i^{th} chroma component. For example, a maximum value of the chroma value of the surrounding reconstructed region of the current chroma block for the i^{th} chroma component is used as the maximum limit value of the predicted value of the current chroma block for the i^{th} chroma component. For another example, a minimum value of the chroma value of the surrounding reconstructed region of the current chroma block for the i^{th} chroma component is used as the minimum limit value of the predicted value of the current chroma block for the i^{th} chroma component.

In embodiments of this application, the surrounding reconstructed region of the current chroma block for the first chroma component may be the same as or different from the surrounding reconstructed region for the second chroma component. Therefore, before the determining, based on the chroma value of the surrounding reconstructed region for the i^{th} chroma component, the limit range of the predicted value of the current chroma block for the i^{th} chroma component, the decoding end first determines a surrounding reconstructed region of the current chroma block for the i^{th} component, and records the surrounding reconstructed region as a first surrounding reconstructed region.

In embodiments of this application, a specific manner of determining the first surrounding reconstructed region of the current chroma block for the i^{th} component includes but is not limited to the following manners.

Manner 1: a default reconstructed region is determined as the first surrounding reconstructed region of the current chroma block for the i^{th} component. For example, an upper reconstructed region of the current chroma block, an upper-left reconstructed region of the current chroma block, and an upper-right reconstructed region of the current chroma block are used by default as the first surrounding reconstructed region of the current chroma block for the i^{th} component. For another example, an upper reconstructed region of the current chroma block, an upper-left reconstructed region of the current chroma block, an upper-right reconstructed region of the current chroma block, a left reconstructed region of the current chroma block, and a lower-left reconstructed region of the current chroma block are used by default as the first surrounding reconstructed region of the current chroma block for the i^{th} component.

For example, the first surrounding reconstructed region of the current chroma block for the Cb chroma component is as shown in FIG. 8A.

For example, the first surrounding reconstructed region of the current chroma block for the Cr chroma component is as shown in FIG. 8B.

Manner 2: In a case that the prediction mode of the current chroma block is a convolutional cross component model mode, a second surrounding reconstructed region corresponding to the convolutional cross component model mode is determined; and the first surrounding reconstructed region is determined based on the second surrounding reconstructed region.

In Manner 2, the decoding end determines the prediction mode of the current chroma block according to the foregoing steps. If the prediction mode of the current chroma block is a convolutional cross component model mode in the cross component intra prediction mode, it may be learned from the foregoing description that, a filter coefficient is required to be determined based on the surrounding reconstructed region of the current chroma block in the convolutional cross component model mode. In embodiments of this application, for ease of description, the surrounding reconstructed region of the current chroma block that is in the convolutional cross component model mode and that is used for determining the filter coefficient is referred to as the second surrounding reconstructed region. In this way, in a case that the prediction mode of the current chroma block is the convolutional cross component model mode, the decoding end determines the second surrounding reconstructed region corresponding to the convolutional cross component model mode, and determines the first surrounding reconstructed region based on the second surrounding reconstructed region.

In embodiments of this application, a specific shape of the second surrounding reconstructed region of the current chroma block is not limited.

In some embodiments, the second surrounding reconstructed region includes any one of a first type of reconstructed region, a second type of reconstructed region, or a third type of reconstructed region.

For example, as shown in FIG. 9A, the first type of reconstructed region includes an upper region, an upper-left region, an upper-right region, a left region, and a lower-left region of the current chroma block. In this case, a model parameter of the CCCM is derived from a surrounding region of the current chroma component and a surrounding region of a corresponding luma block.

For example, as shown in FIG. 9B, the second type of reconstructed region includes an upper region, an upper-left region, and an upper-right region of the current chroma block. In this case, a model parameter of the CCCM is derived from an upper region, an upper-left region, and an upper-right region of the current chroma block and an upper region, an upper-left region, and an upper-right region of the corresponding luma block.

For example, as shown in FIG. 9C, the third type of reconstructed region includes a left region, an upper-left region, and a lower-left region of the current chroma block. In this case, a model parameter of the CCCM is derived from a left region, an upper-left region, and a lower-left region of the current chroma block and a left region, an upper-left region, and a lower-left region of the corresponding luma block.

It should be noted that, in addition to the first type of reconstructed region, the second type of reconstructed region, and the third type of reconstructed region, the second surrounding reconstructed region in embodiments of this application may alternatively be another type of reconstructed region, which is not limited in embodiments of this application.

In some embodiments, if it is determined that the prediction mode of the current chroma block is a convolutional cross component model mode, the decoding end may determine a type of the second surrounding reconstructed region by decoding a related syntax element, that is, determine which type of reconstructed region of the current chroma block is used to derive the model parameter of the CCCM.

The decoding end determines the second surrounding reconstructed region corresponding to the convolutional cross component model mode, and determines the first surrounding reconstructed region based on the second surrounding reconstructed region.

In embodiments of this application, a specific manner in which the decoding end determines the first surrounding reconstructed region based on the second surrounding reconstructed region is not limited.

In some embodiments, a shape of the first surrounding reconstructed region is the same as a shape of the second surrounding reconstructed region.

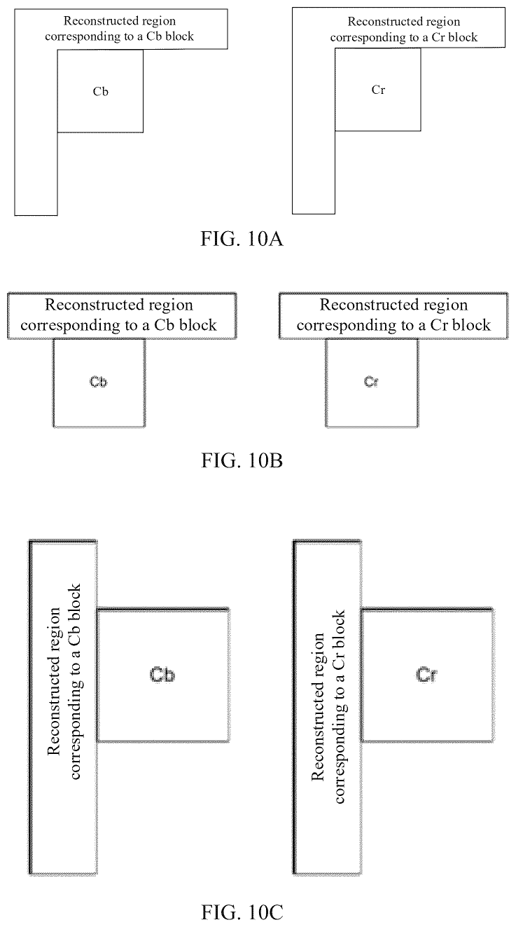

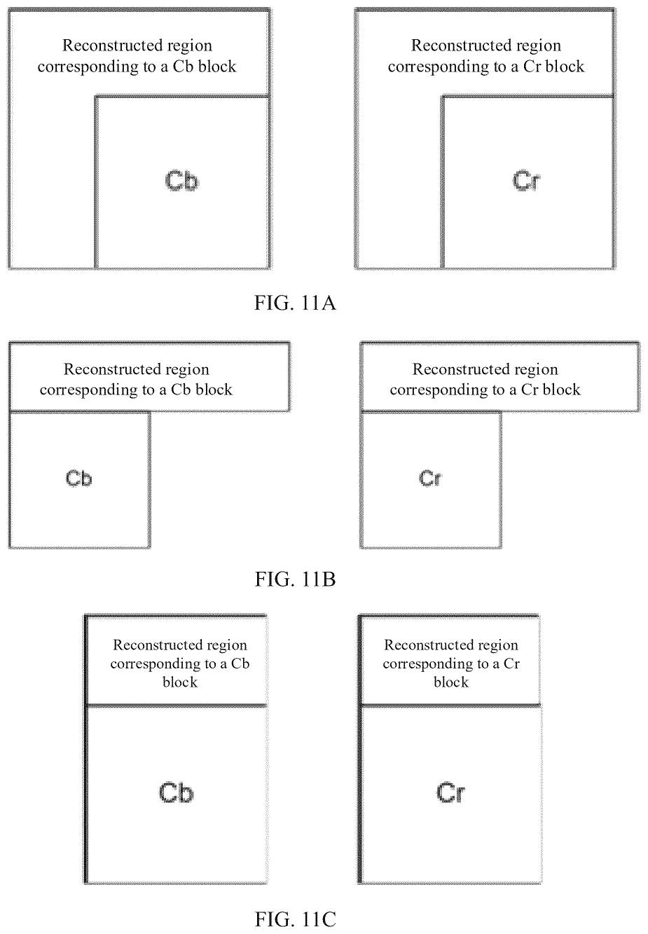

Example 1: if the second surrounding reconstructed region is the first type of reconstructed region, it is determined that the first surrounding reconstructed region is also the first type of reconstructed region. For example, the second surrounding reconstructed region, as shown in FIG. 9A, includes an upper region, an upper-left region, an upper-right region, a left region, and a lower-left region of the current chroma block. In this case, a shape of the first surrounding reconstructed region is the same as a shape of the second surrounding reconstructed region. Specifically, as shown in FIG. 10A, a reconstructed region (that is, the first surrounding reconstructed region) corresponding to each of the Cb component and the Cr component of the current chroma block includes an upper region, an upper-left region, an upper-right region, a left region, and a lower-left region of the current chroma block. Optionally, the first surrounding reconstructed region may include a quantity of rows and a quantity of columns the same as, or different from, or partially the same as and partially different from those included in the second surrounding reconstructed region (for example, the first surrounding reconstructed region includes a quantity of rows the same as that included in the second surrounding reconstructed region and a quantity of columns different from that included in the second surrounding reconstructed region, or the first surrounding reconstructed region includes a quantity of columns the same as that included in the second surrounding reconstructed region and a quantity of rows different from that included in the second surrounding reconstructed region), which is not limited in embodiments of this application.

Example 2: If the second surrounding reconstructed region is the second type of reconstructed region, it is determined that the first surrounding reconstructed region is the second type of reconstructed region. For example, if the second surrounding reconstructed region, as shown in FIG. 9B, includes an upper region, an upper-left region, and an upper-right region of the current chroma block, a shape of the first surrounding reconstructed region is the same as a shape of the second surrounding reconstructed region. Specifically, as shown in FIG. 10B, a reconstructed region (that is, the first surrounding reconstructed region) corresponding to each of the Cb component and the Cr component of the current chroma block includes an upper region, an upper-left region, and an upper-right region of the current chroma block. Optionally, the first surrounding reconstructed region may include a quantity of rows the same as or different from that included in the second surrounding reconstructed region, which is not limited in embodiments of this application.

Example 3: If the second surrounding reconstructed region is the third type of reconstructed region, it is determined that the first surrounding reconstructed region is the third type of reconstructed region. For example, if the second surrounding reconstructed region, as shown in FIG. 9C, includes a left region, an upper-left region, and a lower-left region of the current chroma block, a shape of the first surrounding reconstructed region is the same as a shape of the second surrounding reconstructed region. Specifically, as shown in FIG. 10C, a reconstructed region (that is, the first surrounding reconstructed region) corresponding to each of the Cb component and the Cr component of the current chroma block includes a left region, an upper-left region, and a lower-left region of the current chroma block. Optionally, the first surrounding reconstructed region may include a quantity of rows the same as or different from that included in the second surrounding reconstructed region, which is not limited in embodiments of this application.

In an example, when determining the model parameter of the CCCM based on the second surrounding reconstructed region, the decoding end may also determine the limit range of the predicted value of the current chroma block for the i^{th} chroma component by using the second surrounding reconstructed region. In this case, the first surrounding reconstructed region is the same as the second surrounding reconstructed region.

Manner 3: The first surrounding reconstructed region includes at least one of preset N types of reconstructed regions, where N is a positive integer.

In embodiments of this application, specific shapes of the N types of reconstructed regions are not limited.

In some embodiments, the preset N types of reconstructed regions include five types of reconstructed regions.

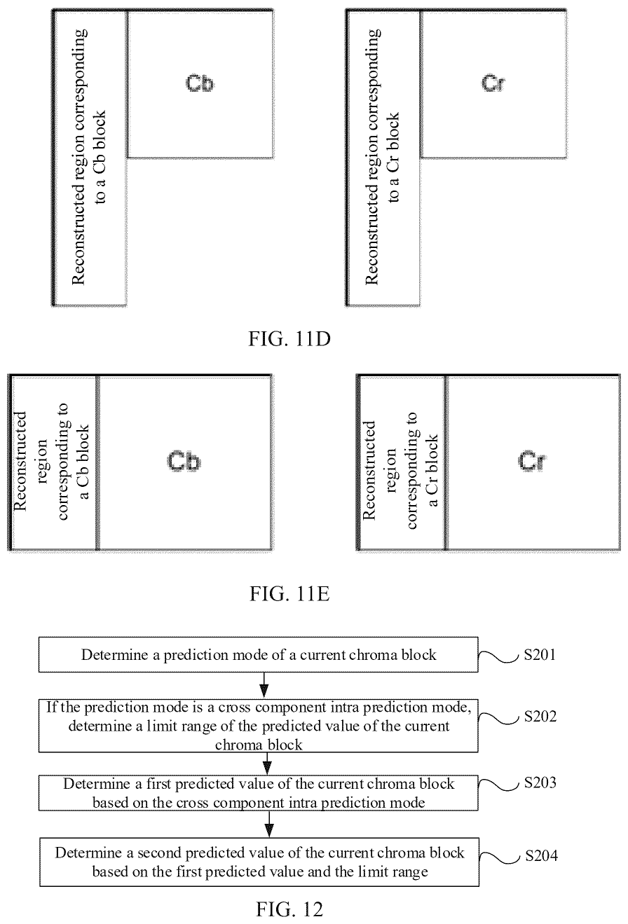

For example, the 1^{st} type of reconstructed region in the five types of reconstructed regions includes an upper region, an upper-left region, and a left region of the current chroma block. As shown in FIG. 11A, the 1^{st} type of reconstructed region of the current chroma block for the Cb chroma component includes an upper region, an upper-left region, and a left region of the current chroma block for the Cb chroma component. The 1^{st} type of reconstructed region of the current chroma block for the Cr chroma component includes an upper region, an upper-left region, and a left region of the current chroma block for the Cr chroma component.

For example, the 2^{nd} type of reconstructed region in the five types of reconstructed regions includes an upper region and an upper-right region of the current chroma block. As shown in FIG. 11B, the 2^{nd} type of reconstructed region of the current chroma block for the Cb chroma component includes an upper region and an upper-right region of the current chroma block for the Cb chroma component. The 2^{nd} type of reconstructed region of the current chroma block for the Cr chroma component includes an upper region and an upper-right region of the current chroma block for the Cr chroma component.

For example, the 3^{rd} type of reconstructed region in the five types of reconstructed regions includes an upper region of the current chroma block. As shown in FIG. 11C, the 3^{rd} type of reconstructed region of the current chroma block for the Cb chroma component includes an upper region of the current chroma block for the Cb chroma component. The 3^{rd} type of reconstructed region of the current chroma block for the Cr chroma component includes an upper region of the current chroma block for the Cr chroma component.

For example, the 4^{th} type of reconstructed region in the five types of reconstructed regions includes an upper-left region and a left region of the current chroma block. As shown in FIG. 11D, the 4^{th} type of reconstructed region of the current chroma block for the Cb chroma component includes an upper-left region and a left region of the current chroma block for the Cb chroma component. The 4^{th} type of reconstructed region of the current chroma block for the Cr chroma component includes an upper-left region and a left region of the current chroma block for the Cr chroma component.

For example, the 5^{th} type of reconstructed region in the five types of reconstructed regions includes a left region of the current chroma block. As shown in FIG. 11E, the 5^{th} type of reconstructed region of the current chroma block for the Cb chroma component includes a left region of the current chroma block for the Cb chroma component. The 5^{th} type of reconstructed region of the current chroma block for the Cr chroma component includes a left region of the current chroma block for the Cr chroma component.

That is, in Manner 3, the decoding end may use any one or more types of reconstructed regions among the N types of reconstructed regions as the first surrounding reconstructed region.

For example, each type of reconstructed region in the N types of reconstructed regions includes at least one row and/or at least one column of reconstructed pixel values. Optionally, six rows and/or six columns of reconstructed pixel values the same as those used in the CCCM and GLM modes may be used.

After determining the first surrounding reconstructed region of the current chroma block for the i^{th} component according to the foregoing method, the decoding end determines the limit range of the predicted value of the current chroma block for the i^{th} chroma component based on the first surrounding reconstructed region.

In embodiments of this application, a specific manner in which the decoding end determines the limit range of the predicted value of the current chroma block for the i^{th} chroma component based on the first surrounding reconstructed region is not limited.

For example, if the limit range of the predicted value of the current chroma block for the i^{th} chroma component includes the maximum limit value of the predicted value of the current chroma block for the i^{th} chroma component, the decoding end determines that a maximum chroma value of the surrounding reconstructed region for the i^{th} chroma component is the maximum limit value of the predicted value of the current chroma block for the i^{th} chroma component.

For another example, if the limit range of the predicted value of the current chroma block for the i^{th} chroma component includes the minimum limit value of the predicted value of the current chroma block for the i^{th} chroma component, the decoding end determines that a minimum chroma value of the surrounding reconstructed region for the i^{th} chroma component is the minimum limit value of the predicted value of the current chroma block for the i^{th} chroma component.

For another example, if the limit range of the predicted value of the current chroma block for the i^{th} chroma component includes the maximum limit value and the minimum limit value of the predicted value of the current chroma block for the i^{th} chroma component, the decoding end determines that a maximum chroma value of the surrounding reconstructed region for the i^{th} chroma component is the maximum limit value of the predicted value of the current chroma block for the i^{th} chroma component, and determines that a minimum chroma value of the surrounding reconstructed region for the i^{th} chroma component is the minimum limit value of the predicted value of the current chroma block for the i^{th} chroma component.

For another example, if the limit range of the predicted value of the current chroma block for the i^{th} chroma component includes the maximum limit value of the predicted value of the current chroma block for the i^{th} chroma component, the decoding end determines that an average value of a plurality of maximum chroma values of the surrounding reconstructed region for the i^{th} chroma component is the maximum limit value of the current chroma block for the i^{th} chroma component.

For another example, if the limit range of the predicted value of the current chroma block for the i^{th} chroma component includes the minimum limit value of the predicted value of the current chroma block for the i^{th} chroma component, the decoding end determines that an average value of a plurality of minimum chroma values of the surrounding reconstructed region for the i^{th} chroma component is the minimum limit value of the predicted value of the current chroma block for the i^{th} chroma component.

For another example, if the limit range of the predicted value of the current chroma block for the i^{th} chroma component includes the maximum limit value and the minimum limit value of the predicted value of the current chroma block for the i^{th} chroma component, the decoding end determines that an average value of a plurality of maximum chroma values of the surrounding reconstructed region for the i^{th} chroma component is the maximum limit value of the predicted value of the current chroma block for the i^{th} chroma component, and determines that an average value of a plurality of minimum chroma values of the surrounding reconstructed region for the i^{th} chroma component is the minimum limit value of the predicted value of the current chroma block for the i^{th} chroma component.

In the foregoing embodiment, a specific process in which the decoding end determines the limit range of the predicted value of the current chroma block is described.

In S103, a first predicted value of the current chroma block is determined based on the cross component intra prediction mode.

It should be noted that, the steps of determining the limit range of the predicted value of the current chroma block in S103 and S102 are not performed in strict order. That is, if it is determined that the prediction mode of the current chroma block is the cross component intra prediction mode, the decoding end may first perform S103 of determining a first predicted value of the current chroma block, and then perform S102 of determining the limit range of the predicted value of the current chroma block. Alternatively, the decoding end may first perform S102 of determining the limit range of the predicted value of the current chroma block, and then perform S103 of determining a first predicted value of the current chroma block based on the cross component intra prediction mode. Alternatively, the decoding end may simultaneously perform S103 of determining a first predicted value of the current chroma block based on the cross component intra prediction mode and S102 of determining the limit range of the predicted value of the current chroma block. A performing order of S102 and S103 is determined depending on an actual situation, and is not limited in embodiments of this application.

In embodiments of this application, for ease of description, the predicted value of the current chroma block obtained based on the cross component intra prediction mode is referred to as the first predicted value of the current chroma block.

In embodiments of this application, a specific manner of determining the first predicted value of the current chroma block varies depending on a cross component intra prediction mode used for the current chroma block.

In some embodiments, if the cross component intra prediction mode used for the current chroma block is the CCCM mode, the decoding end determines a first preset value of the current chroma block according to the formula (7).

In some embodiments, if the cross component intra prediction mode used for the current chroma block is the GLM mode, the decoding end determines a first preset value of the current chroma block according to the formula (8) or the formula (9).

In some embodiments, the decoding end determines a first predicted value of the current chroma block for each of the two chroma components. That is, for the i^{th} chroma component of the current chroma block, the decoding end determines the first predicted value of the current chroma block for the i^{th} chroma component based on the cross component intra prediction mode. For example, the decoding end determines the first predicted value of the current chroma block for the first chroma component (the Cb or U component) based on the cross component intra prediction mode, and the decoding end determines the first predicted value of the current chroma block for the second chroma component (the Cr or V component) based on the cross component intra prediction mode.

The decoding end determines the limit range of the predicted value of the current chroma block by performing S102, and determines the first predicted value of the current chroma block by performing S103. Next, the following step S104 is performed.

In S104, a second predicted value of the current chroma block is determined based on the first predicted value and the limit range.

In embodiments of this application, if the prediction mode of the current chroma block is the cross component intra prediction mode, the limit range of the predicted value of the current chroma block is determined to improve prediction performance. Then, the first predicted value determined based on the cross component intra prediction mode is limited based on the limit range, thereby preventing the first predicted value obtained based on the cross component intra prediction mode from being excessively large or small, thus improving prediction accuracy of the current chroma block and enhancing decoding performance.

In embodiments of this application, a specific manner in which the decoding end determines a second predicted value of the current chroma block based on the first predicted value and the limit range is not limited.

In some embodiments, it is assumed that the predicted values for the first chroma component and the second chroma component correspond to a same limit range. For example, if the first chroma component and the second chroma component correspond to a maximum limit value a, the maximum limit value a is used to limit the first predicted value of the current chroma block for the first chroma component and the first predicted value of the current chroma block for the second chroma component. If the first chroma component and the second chroma component correspond to a minimum limit value b, the minimum limit value b is used to limit the first predicted value of the current chroma block for the first chroma component and the first predicted value of the current chroma block for the second chroma component.

For example, if the first predicted value of the current chroma block for the first chroma component is less than the maximum limit value a, the first predicted value of the current chroma block for the first chroma component is determined as the second predicted value of the current chroma block for the first chroma component. If the first predicted value of the current chroma block for the first chroma component is greater than the maximum limit value a, the maximum limit value a is determined as the second predicted value of the current chroma block for the first chroma component. If the first predicted value of the current chroma block for the second chroma component is less than the maximum limit value a, the first predicted value of the current chroma block for the second chroma component is determined as the second predicted value of the current chroma block for the second chroma component. If the first predicted value of the current chroma block for the second chroma component is greater than the maximum limit value a, the maximum limit value a is determined as the second predicted value of the current chroma block for the second chroma component.

For another example, if the first predicted value of the current chroma block for the first chroma component is greater than the minimum limit value b, the first predicted value of the current chroma block for the first chroma component is determined as the second predicted value of the current chroma block for the first chroma component. If the first predicted value of the current chroma block for the first chroma component is less than the minimum limit value b, the minimum limit value b is determined as the second predicted value of the current chroma block for the first chroma component. If the first predicted value of the current chroma block for the second chroma component is greater than the minimum limit value b, the first predicted value of the current chroma block for the second chroma component is determined as the second predicted value of the current chroma block for the second chroma component. If the first predicted value of the current chroma block for the second chroma component is less than the minimum limit value b, the minimum limit value b is determined as the second predicted value of the current chroma block for the second chroma component.

In some embodiments, predicted values for the first chroma component and the second chroma component correspond to a same limit range. An i^{th} chroma component is used as an example. In this case, the decoding end may determine the second predicted value of the current chroma block for the i^{th} chroma component based on the first predicted value for the i^{th} chroma component and the limit range for the i^{th} chroma component.

In an example, if the limit range for the i^{th} chroma component includes a maximum limit value, the maximum limit value for the i^{th} chroma component is used to limit the first predicted value of the current chroma block for the i^{th} chroma component.

For example, if the first predicted value of the current chroma block for the i^{th} chroma component is less than or equal to the maximum limit value for the i^{th} chroma component, the first predicted value of the current chroma block for the i^{th} chroma component is determined as the second predicted value of the current chroma block for the i^{th} chroma component.

For another example, if the first predicted value of the current chroma block for the i^{th} chroma component is greater than the maximum limit value for the i^{th} chroma component, the maximum limit value for the i^{th} chroma component is determined as the second predicted value of the current chroma block for the i^{th} chroma component.

In an example, if the limit range for the i^{th} chroma component includes a minimum limit value, the minimum limit value for the i^{th} chroma component is used to limit the first predicted value of the current chroma block for the i^{th} chroma component.

For example, if the first predicted value of the current chroma block for the i^{th} chroma component is greater than or equal to the minimum limit value for the i^{th} chroma component, the first predicted value of the current chroma block for the i^{th} chroma component is determined as the second predicted value of the current chroma block for the i^{th} chroma component.

For another example, if the first predicted value of the current chroma block for the i^{th} chroma component is less than the minimum limit value for the i^{th} chroma component, the minimum limit value for the i^{th} chroma component is determined as the second predicted value of the current chroma block for the i^{th} chroma component.

In an example, if the limit range for the i^{th} chroma component includes a maximum limit value and a minimum limit value, the maximum limit value and the minimum limit value for the i^{th} chroma component are used to limit the first predicted value of the current chroma block for the i^{th} chroma component.

For example, if the first predicted value of the current chroma block for the i^{th} chroma component is less than or equal to the maximum limit value for the i^{th} chroma component and greater than or equal to the minimum limit value for the i^{th} chroma component, the first predicted value of the current chroma block for the i^{th} chroma component is determined as the second predicted value of the current chroma block for the i^{th} chroma component.

For another example, if the first predicted value of the current chroma block for the i^{th} chroma component is greater than the maximum limit value for the i^{th} chroma component, the maximum limit value for the i^{th} chroma component is determined as the second predicted value of the current chroma block for the i^{th} chroma component.

For another example, if the first predicted value of the current chroma block for the i^{th} chroma component is less than the minimum limit value for the i^{th} chroma component, the minimum limit value for the i^{th} chroma component is determined as the second predicted value of the current chroma block for the i^{th} chroma component.

In embodiments of this application, the predicted value of the current chroma block is determined on a per-pixel basis. That is, the decoding end predicts a predicted value of each pixel in the current chroma block to obtain a first predicted value of each pixel, and limits the first predicted value of each pixel to obtain a second predicted value of each pixel. A process in which the decoding end obtains the second predicted values of different pixels by limiting the first predicted values of respective pixels in the current chroma block is identical. Herein, a current location (x, y) within the current chroma block is used as an example for description.

For example, for the current location (x, y) within the current chroma block, a process of limiting a Cb predicted value and a Cr predicted value of the current location (x, y) is shown in Table 2.

TABLE 2

| | |
|---|---|
| for ( y = 0; y < height; y++){ | |
| for ( x = 0; x < width; x++ ){ | |
| if(PredCb_{(x,y)} > max_{cb}) | If the Cb predicted value of the current |
| | location is greater than a maximum |
| | limit value, |
| PredCb_{(x,y)} = max_{cb} | the maximum limit value is assigned to |
| | the Cb predicted value of the current |
| | location. |
| if(PredCb_{(x,y)} < min_{cb}) | If the Cb predicted value of the current |
| | location is less than a minimum limit |
| | value, |
| PredCb_{(x,y)} = min_{cb} | the minimum limit value is assigned to |
| | the Cb predicted value of the current |
| | location. |
| if(PredCr_{(x,y)} > max_{cr}) | If the Cr predicted value of the current |
| | location is greater than a maximum |
| | limit value, |
| PredCr_{(x,y)} = max_{cr} | the maximum limit value is assigned to |
| | the Cr predicted value of the current |
| | location. |
| if(PredCr_{(x,y)} < min_{cr}) | If the Cr predicted value of the current |
| | location is less than a minimum limit |
| | value, |
| PredCr_{(x,y)} = min_{cr} | the minimum limit value is assigned to |
| | the Cr predicted value of the current |
| | location. |
| } | |
| } | |

In Table 2, height denotes a height of the current chroma block, and width denotes a width of the current chroma block. PredCb_{(x,y)} denotes a predicted value (that is, the first predicted value) of the pixel at the location (x, y) within the current chroma block for the Cb component. max_{cb} denotes a maximum limit value corresponding to the Cb component of the current chroma block. min_{cb} denotes a minimum limit value corresponding to the Cb component of the current chroma block. PredCr_{(x,y)} denotes a predicted value (that is, the first predicted value) of the pixel at the location (x, y) within the current chroma block for the Cr component. max_{cr} denotes a maximum limit value corresponding to the Cr component of the current chroma block. min_{cr} denotes a minimum limit value corresponding to the Cr component of the current chroma block.

According to Table 2, if the Cb predicted value (that is, the first predicted value for the Cb component) of the current location (x, y) within the current chroma block that is determined based on the cross component intra prediction mode is greater than a maximum limit value max_{cb} for the Cb component, max_{cb} is determined as the Cb predicted value (that is, the second predicted value) of the current location (x, y). If the Cb predicted value (that is, the first predicted value for the Cb component) of the current location (x, y) that is determined based on the cross component intra prediction mode is less than a minimum limit value min_{cb} for the Cb component, min_{cb} is determined as the Cb predicted value (that is, the second predicted value) of the current location (x, y). Similarly, if the Cr predicted value (that is, the first predicted value for the Cr component) of the current location (x, y) within the current chroma block that is determined based on the cross component intra prediction mode is greater than a maximum limit value max_{cr} for the Cr component, max_{cr} is determined as the Cr predicted value (that is, the second predicted value) of the current location (x, y). If the Cr predicted value (that is, the first predicted value for the Cr component) of the current location (x, y) that is determined based on the cross component intra prediction mode is less than a minimum limit value min_{cr} for the Cr component, min_{cr} is determined as the Cr predicted value (that is, the second predicted value) of the current location (x, y).

The decoding end may determine the second predicted value of the current chroma block according to the foregoing steps, and may further decode the current chroma block based on the second predicted value to obtain a reconstructed value of the current chroma block.

According to the video decoding method provided in embodiments of this application, a prediction mode of a current chroma block is determined when predicting the current chroma block; in a case that the prediction mode is a cross component intra prediction mode, a limit range of a predicted value of the current chroma block is determined, where the limit range includes at least one of a maximum limit value or a minimum limit value of the predicted value; next, a first predicted value of the current chroma block is determined based on the cross component intra prediction mode; and a second predicted value of the current chroma block is determined based on the first predicted value and the limit range. That is, in embodiments of this application, in a case that the cross component intra prediction mode is used for the current chroma block, the first predicted value determined based on the cross component intra prediction mode is limited, thereby preventing the predicted value of the current chroma block from being excessively large or small, thus improving prediction accuracy of the current chroma block and enhancing video coding performance.

The foregoing describes the prediction method in this application by using the decoding end as an example. The following description is given by using the encoding end as an example.

FIG. 12 is a schematic flowchart of a prediction method according to an embodiment of this application. This embodiment of this application is applied to the video encoder shown in FIG. 1 and FIG. 2. As shown in FIG. 12, the method in embodiments of this application includes the following steps S201 to S204.

In S201, a prediction mode of a current chroma block is determined.

In embodiments of this application, when encoding the current block, the encoding end first performs prediction encoding on a luma component of the current block, to obtain a luma reconstructed value of the current block. Next, prediction encoding is performed on a chroma component of the current block.

In embodiments of this application, the chroma component of the current block is referred to as the current chroma block.

Before prediction encoding is performed on the current chroma block, the prediction mode of the current chroma block is first determined.

In embodiments of this application, a specific manner of determining the prediction mode of the current chroma block is not limited.

In some embodiments, a default prediction mode is determined as the prediction mode of the current chroma block. That is, in embodiments of this application, both the encoding end and the decoding end predict the current chroma block by using the default prediction mode.

In some embodiments, the encoding end determines, from a plurality of candidate prediction modes, a prediction mode having the minimum cost as the prediction mode of the current chroma block. Optionally, the encoding end encodes indication information of the prediction mode into a bitstream, for example, encodes a mode index of the prediction mode into a bitstream.

In some embodiments, S201 includes the following steps.

In S201-A1, a first prediction mode is determined.

In S201-A2, the prediction mode of the current chroma block is determined based on the first prediction mode.

It may be learned from the foregoing description that, the cross component intra prediction mode includes modes such as CCLM, CCCM, GLM, and CCMerge. In the CCMerge mode, the prediction mode of the current chroma block is determined by constructing a list.

In some embodiments, the first prediction mode may be a default mode, for example, the encoding end and the decoding end use the CCMerge mode as the first prediction mode by default.

In some embodiments, the encoding end may determine the first prediction mode based on an enable flag of the prediction mode. For example, if the enable flag of the CCCM mode is equal to 1, it indicates that the CCCM mode is used. In this case, it is determined that the first prediction mode is the CCCM mode. Alternatively, if the enable flag of the CCMerge mode is equal to 1, it indicates that the CCMerge mode is used. In this case, it is determined that the first prediction mode is the CCMerge mode.

After determining the first prediction mode, the encoding end determines the prediction mode of the current chroma block based on the first prediction mode.

The operation of determining the prediction mode of the current chroma block based on the first prediction mode includes at least the following two cases.

Case 1: If the first prediction mode is the CCCM mode or the GLM mode, the encoding end directly determines the CCCM mode or the GLM mode as the prediction mode of the current chroma block.

Case 2: If the first prediction mode is a cross component merge mode, S201-A2 includes the following steps:

In S201-A21, a cross component prediction mode list is constructed by inheriting a cross component intra prediction mode of a chroma block surrounding the current chroma block that is adjacent and/or non-adjacent to the current chroma block.

In S201-A22, the prediction mode of the current chroma block is determined based on the cross component prediction mode list.

In Case 2, if the first prediction mode is the CCMerge mode, the encoding end constructs a cross component prediction mode list having a length of N.

For example, a process in which the encoding end constructs the cross component prediction mode list may include the following steps.

First, the encoding end obtains a cross component intra prediction mode of a chroma block at a surrounding location adjacent to the current chroma block. For example, as shown in FIG. 6E, the encoding end sequentially accesses the locations B1→A1→B0→A0→B2. If the cross component intra prediction mode is used for at least one of the chroma blocks at these locations, the cross component intra prediction mode of the at least one chroma block is stored in the cross component prediction mode list. For example, cross component intra prediction modes may be stored in the cross component prediction mode list in the same order as the access order of the locations.

In some embodiments, if the length of the cross component prediction mode list does not meet a preset length, that is, N, the encoding end may further obtain a cross component intra prediction mode of a chroma block at a location non-adjacent to the current chroma block. Non-adjacent locations include an upper location, an upper-left location, an upper-right location, a left location, and a lower-left location of the current chroma block.

In some embodiments, if the length of the cross component prediction mode list does not meet a preset length, namely, N, that is, if a quantity of cross component intra prediction modes obtained from locations adjacent and non-adjacent to the current chroma block does not meet N, remaining entries in the list are filled with the CCLM mode with a default slope.

After constructing the cross component prediction mode list according to the foregoing steps, the encoding end determines the prediction mode of the current chroma block based on the cross component prediction mode list.

In embodiments of this application, a specific manner of determining the prediction mode of the current chroma block based on the cross component prediction mode list is not limited.

In an example, the encoding end uses by default a cross component intra prediction mode in the cross component prediction mode list as the prediction mode of the current chroma block. For example, the 1^{st} cross component intra prediction mode in the cross component prediction mode list is used by default as the prediction mode of the current chroma block. Alternatively, the 2^{nd} cross component intra prediction mode in the cross component prediction mode list is used by default as the prediction mode of the current chroma block.

In an example, the encoding end determines a mode having the minimum cost in the cross component prediction mode list as the prediction mode of the current chroma block.

In an example, after determining the prediction mode of the current chroma block, the encoding end writes a mode index of the prediction mode of the current chroma block in the cross component prediction mode list into a bitstream. In this way, the decoding end may decode the bitstream to obtain the mode index, and then determines the prediction mode of the current chroma block from the cross component prediction mode list based on the mode index.

In some embodiments, after determining the prediction mode of the current chroma block according to the foregoing steps, the encoding end writes the prediction mode into a bitstream, such that the decoding end obtains the prediction mode of the current chroma block by decoding the bitstream.

In S202, if the prediction mode is a cross component intra prediction mode, a limit range of the predicted value of the current chroma block is determined.

The limit range includes at least one of a maximum limit value or a minimum limit value of the predicted value.

In embodiments of this application, to further improve prediction accuracy of the cross component intra prediction mode, in a case that the cross component intra prediction mode is used for the current chroma block, the limit range of the predicted value of the current chroma block is determined, so that the predicted value of the current chroma block is limited within the limit range, thereby preventing the predicted value of the current chroma block that is obtained by prediction from being excessively large or small due to prediction errors, thus further improving prediction accuracy of the chroma component.

It should be noted that, in embodiments of this application, a value range of the predicted value of the chroma component is limited. In some embodiments, a value range of a predicted value of the luma component and the like may also be limited.

In some embodiments, limiting the predicted value of the current chroma block may include: limiting a maximum value of the predicted value of the current chroma block, and recording the limit value as the maximum limit value of the predicted value. That is, the predicted value of the current chroma block is limited so as not to exceed the maximum limit value.

In some embodiments, limiting the predicted value of the current chroma block may include: limiting a minimum value of the predicted value of the current chroma block, and recording the limit value as the minimum limit value of the predicted value. That is, the predicted value of the current chroma block is limited so as not to be less than the minimum limit value.

In some embodiments, limiting the predicted value of the current chroma block may include: limiting both the maximum value and the minimum value of the predicted value of the current chroma block. That is, the predicted value of the current chroma block is limited so as not to be less than the minimum limit value, and the predicted value of the current chroma block is limited so as not to exceed the maximum limit value.

In some embodiments, a flag (that is, a first flag) is used to indicate whether the encoding end limits the predicted value of the current chroma block. In this case, before determining the limit range of the predicted value of the current chroma block, the encoding end is first required to determine a first flag corresponding to the current chroma block. The first flag is used to indicate whether to limit the predicted value of the current chroma block. In this way, the encoding end determines, based on the first flag, whether to limit a value range of the predicted value of the current chroma block.

For example, if the first flag indicates that the predicted value of the current chroma block is not to be limited, the encoding end skips the step of determining the limit range of the predicted value of the current chroma block.

For another example, if the first flag indicates that the predicted value of the current chroma block is to be limited, the encoding end determines the limit range of the predicted value of the current chroma block.

In embodiments of this application, a specific manner in which the encoding end determines the first flag corresponding to the current chroma block is not limited.

In some embodiments, if the encoding end determines that the first prediction mode is the CCMerge mode, the encoding end determines a cross component intra prediction mode of the current chroma block by inheriting a cross component intra prediction mode of a chroma block surrounding the current chroma block that is adjacent and/or non-adjacent to the current chroma block. For example, referring to the foregoing embodiments, if the encoding end inherits a cross component intra prediction mode of a chroma block 1, in this embodiment, the encoding end may further inherit a first flag of the chroma block 1. That is, if the first prediction mode is the CCMerge mode, the encoding end determines a chroma block corresponding to a prediction mode inherited by the current chroma block, and determines a first flag corresponding to the chroma block as the first flag corresponding to the current chroma block.

In some embodiments, the encoding end may obtain the first flag from high-level semantics.

In embodiments of this application, a specific representation of the first flag is not limited, and the first flag may be understood as any information that may indicate whether to limit the predicted value of the current chroma block.

In an example, the first flag may be denoted as cross_component_clip_flag. In this way, different values are assigned to cross_component_clip_flag to indicate whether to limit the predicted value of the current chroma block. For example, if a value of cross_component_clip_flag is a first value, it indicates that the predicted value of the current chroma block is to be limited. If a value of cross_component_clip_flag is a second value, it indicates that the predicted value of the current chroma block is not to be limited.

Specific values of the first value and the second value are not limited in embodiments of this application.

For example, the first value is 1.

For example, the second value is 0.

In this embodiment, the encoding end determines the prediction mode of the current chroma block according to the foregoing steps. If it is determined that the prediction mode of the current chroma block is the cross component intra prediction mode (for example, the CCCM mode or the GLM mode), the encoding end determines the first flag corresponding to the current chroma block, and then determines whether to limit the predicted value of the current chroma block based on the first flag. Specifically, if a value of the first flag is the first value, it indicates that the predicted value of the current chroma block is to be limited. In this way, the encoding end determines the limit range of the predicted value of the current chroma block. If a value of the first flag is the second value, it indicates that the predicted value of the current chroma block is not to be limited. In this case, the encoding end skips the step of determining the limit range of the predicted value of the current chroma block, and directly uses a predicted value obtained based on the cross component intra prediction mode as the predicted value of the current chroma block.

In some embodiments, if the encoding end fails to obtain the first flag from high-level semantics, a value of the first flag is set by default to the second value, indicating that the predicted value of the current chroma block is not to be limited.

In some embodiments, the encoding end may further write the first flag into a bitstream, such that the decoding end may decode the bitstream to obtain the first flag corresponding to the current chroma block.

For example, syntax elements included in the bitstream are shown in Table 1.

In some embodiments, whether the encoding end limits the predicted value of the current chroma block is indicated by determining whether the current chroma block meets a preset condition. That is, in embodiments of this application, ranges of predicted values of some chroma blocks are limited, but ranges of predicted values of some chroma blocks are not limited. In this case, before determining the limit range of the predicted value of the current chroma block, the encoding end is first required to determine whether the current chroma block meets the preset condition.

For example, if the current chroma block does not meet the preset condition, the encoding end skips the step of determining the limit range of the predicted value of the current chroma block.

For another example, if the current chroma block meets the preset condition, the encoding end performs the step of determining the limit range of the predicted value of the current chroma block.

In embodiments of this application, the preset condition is not limited, and may be specifically set according to actual requirements.

In some embodiments, the preset condition includes at least one of the following:
the current chroma block is not a first-row chroma block of a current CTU;
a size of the current chroma block meets a preset size; or
a shape of the current chroma block meets a preset shape.

That is, in embodiments of this application, the preset condition may include any one of the foregoing three conditions, or any two of the foregoing three conditions, or all of the foregoing three conditions.

In an example, both the CCCM and GLM modes require reconstructed pixel values from a plurality of rows and a plurality of columns to derive model parameters. In the ECM reference software, to reduce storage of row buffers across CTUs, the use of the CCCM and GLM modes is limited for a block located at an upper boundary of a CTU. Accordingly, in embodiments of this application, a method for determining the limit range of the predicted value of the current chroma block is also limited. That is, in a case that the current chroma block is the first-row chroma block of the current CTU, the step of determining the limit range of the predicted value of the current chroma block is skipped.

In an example, the size of the current chroma block meeting the preset size may refer to that at least one of a length or a width of the current chroma block meets a preset value, for example, the length of the current chroma block is less than or equal to a preset length and the width is less than or equal to a preset width. For another example, the length of the current chroma block is less than or equal to a preset length. For another example, the width of the current chroma block is less than or equal to a preset width.

In an example, the size of the current chroma block meeting the preset size may refer to that a quantity of pixels included in the current chroma block meets a preset quantity.

In an example, the shape of the current chroma block meeting the preset shape may refer to that at least one of a length-to-width ratio or a width-to-length ratio of the current chroma block meets a preset ratio. For example, the length-to-width ratio of the current chroma block is less than or equal to a first ratio, and the width-to-length ratio is less than or equal to a second ratio. For another example, the length-to-width ratio of the current chroma block is less than or equal to a first ratio. For another example, the width-to-length ratio is less than or equal to a second ratio.

It may be learned from the foregoing description that, in embodiments of this application, a manner of determining whether to limit the predicted value of the current chroma block includes at least the following several examples.

Example 1: The encoding end limits the predicted value of the current chroma block by default. That is, when it is determined that the prediction mode of the current chroma block is the cross component intra prediction mode, the encoding end determines the limit range of the predicted value of the current chroma block.

Example 2: Whether to limit the predicted value of the current chroma block is indicated using the first flag. In this case, when determining that the prediction mode of the current chroma block is the cross component intra prediction mode, the encoding end is also required to determine the first flag corresponding to the current chroma block, and further determine, based on the first flag, whether to limit the predicted value of the current chroma block. For example, if the first flag indicates that the predicted value of the current chroma block is to be limited, the encoding end determines the limit range of the predicted value of the current chroma block. For another example, if the first flag indicates that the predicted value of the current chroma block is not to be limited, the encoding end skips the step of determining the limit range of the predicted value of the current chroma block.

Example 3: Whether to limit the predicted value of the current chroma block is determined by determining whether the current chroma block meets the preset condition. That is, when determining that the prediction mode of the current chroma block is the cross component intra prediction mode, the encoding end determines whether the current chroma block meets the preset condition. If the current chroma block meets the preset condition, the encoding end determines the limit range of the predicted value of the current chroma block. For another example, if the current chroma block does not meet the preset condition, the encoding end skips the step of determining the limit range of the predicted value of the current chroma block.

Example 4: Whether to limit the predicted value of the current chroma block is determined based on the first flag and the preset condition. That is, in Example 4, if the first flag corresponding to the current chroma block indicates that the predicted value of the current chroma block is to be limited, and the current chroma block meets the preset condition, the encoding end determines the limit range of the predicted value of the current chroma block. If the first flag of the current chroma block indicates that the predicted value of the current chroma block is not to be limited, and/or the current chroma block does not meet the preset condition, the encoding end skips the step of determining the limit range of the predicted value of the current chroma block. In Example 4, the encoding end may first determine whether the current chroma block meets the preset condition. If the current chroma block does not meet the preset condition, the encoding end does not determine the first flag, and directly skips the step of determining the limit range of the predicted value of the current chroma block. If it is determined that the current chroma block meets the preset condition, the encoding end determines the first flag corresponding to the current chroma block. If the first flag indicates that the predicted value of the current chroma block is to be limited, the encoding end determines the limit range of the predicted value of the current chroma block. If the first flag indicates that the predicted value of the current chroma block is not to be limited, the encoding end skips the step of determining the limit range of the predicted value of the current chroma block.

The following describes a specific process in which the encoding end determines the limit range of the predicted value of the current chroma block.

In embodiments of this application, the encoding end determines the limit range of the predicted value of the current chroma block by the following manners.

Manner 1: The limit range of the predicted value of the current chroma block is a preset value. That is, at least one of the maximum limit value or the minimum limit value of the predicted value of the current chroma block is a preset value. The preset value may be an empirical value or an experimental value, which is not limited in embodiments of this application.

Manner 2: If the encoding end determines that the first prediction mode is the CCMerge mode, the encoding end inherits a cross component intra prediction mode of a chroma block surrounding the current chroma block that is adjacent and/or non-adjacent to the current chroma block. For example, referring to the foregoing embodiments, the encoding end inherits the cross component intra prediction mode of the chroma block 1. In this embodiment, the encoding end may further inherit a limit range of a predicted value of the chroma block 1. That is, if the first prediction mode is the CCMerge mode, the encoding end determines a chroma block corresponding to a prediction mode inherited by the current chroma block, and determines a limit range of a predicted value of the chroma block as the limit range of the predicted value of the current chroma block.

Manner 3: a chroma value of the current chroma block is correlated with a chroma block within a region surrounding the current chroma block; based on this, S202 includes the following step S202-A.

In S202-A, the limit range of the predicted value of the current chroma block is determined based on a chroma value of a surrounding reconstructed region of the current chroma block.

In embodiments of this application, the chroma component includes a first chroma component and a second chroma component. The first chroma component may be a U component or a Cb component, and the second chroma component may be a V component or a Cr component. In this way, the encoding end may determine a limit range of a predicted value of the current chroma block for each of the first chroma component and the second chroma component, based on a chroma value of the surrounding reconstructed region of the current chroma block for each of the first chroma component and the second chroma component.

In embodiments of this application, a specific manner in which the encoding end determines the limit range of the predicted value of the current chroma block for each of the first chroma component and the second chroma component based on the chroma value of the surrounding reconstructed region of the current chroma block for each of the first chroma component and the second chroma component is not limited.

In some embodiments, the encoding end determines a maximum limit value and/or a minimum limit value of the predicted value of the current chroma block based on a chroma value of the surrounding reconstructed region of the current chroma block. That is, the predicted value of the current chroma block for each of the first chroma component and the second chroma component is limited so as not to exceed the maximum limit value, and/or the predicted value of the current chroma block for each of the first chroma component and the second chroma component is limited so as not to be less than the minimum limit value. For example, a maximum chroma value of the surrounding reconstructed region of the current chroma block is used as the maximum limit value of the predicted value of the current chroma block. In this case, the maximum chroma value is the maximum of the chroma values for the first chroma component and the second chroma component. For another example, a minimum chroma value of the surrounding reconstructed region of the current chroma block is used as the minimum limit value of the predicted value of the current chroma block. In this case, the minimum limit value is the minimum of the chroma value of the surrounding reconstructed region for the first chroma component and the chroma value of the surrounding reconstructed region for the second chroma component.

In some embodiments, since a chroma value of each pixel in the surrounding reconstructed region of the current chroma block has been reconstructed, the encoding end may find a pixel 1 having the largest chroma value for the first chroma component or the second chroma component within the surrounding reconstructed region of the current chroma block, and further determine the chroma value of the pixel 1 as the limit range of the predicted value of the current chroma block. That is, the encoding end determines the chroma value of the pixel 1 for the first chroma component as the maximum limit value of the current chroma block for the first chroma component, and determines the chroma value of the pixel 1 for the second chroma component as the maximum limit value of the current chroma block for the second chroma component. Alternatively, the encoding end may find a pixel 2 having the smallest chroma value for the first chroma component or the second chroma component within the surrounding reconstructed region of the current chroma block, and further determine the chroma value of the pixel 2 as the limit range of the predicted value of the current chroma block. That is, the encoding end determines the chroma value of the pixel 2 for the first chroma component as the minimum limit value of the current chroma block for the first chroma component, and determines the chroma value of the pixel 2 for the second chroma component as the minimum limit value of the current chroma block for the second chroma component. In this case, each of the first chroma component and the second chroma component corresponds to one limit range.

In some embodiments, the encoding end determines a predicted value of the current chroma block for each of the first chroma component and the second chroma component. Accordingly, determining a limit range of the predicted value of the current chroma block for the first chroma component is independent of determining a limit range of the predicted value of the current chroma block for the second chroma component. A specific process of determining the limit range of the predicted value for the first chroma component is basically the same as a specific process of determining the limit range of the predicted value for the second chroma component. For ease of description, determining the limit range of the predicted value of the current chroma block for an i^{th} chroma component is used herein as an example for description. The i^{th} chroma component may be the first chroma component (a U component or a Cb component), or may be the second chroma component (a V component or a Cr component). Based on this, S202-A includes the following step S202-A1.

In S202-A1, a limit range of a predicted value of the current chroma block for an i^{th} chroma component is determined based on a chroma value of the surrounding reconstructed region for the i^{th} chroma component.

In embodiments of this application, the encoding end determines the limit range of the predicted value of the current chroma block for the i^{th} chroma component based on the chroma value of the surrounding reconstructed region of the current chroma block for the i^{th} chroma component. For example, a maximum value of the chroma value of the surrounding reconstructed region of the current chroma block for the i^{th} chroma component is used as the maximum limit value of the predicted value of the current chroma block for the i^{th} chroma component. For another example, a minimum value of the chroma value of the surrounding reconstructed region of the current chroma block for the i^{th} chroma component is used as the minimum limit value of the predicted value of the current chroma block for the i^{th} chroma component.

In embodiments of this application, the surrounding reconstructed region of the current chroma block for the first chroma component may be the same as or different from the surrounding reconstructed region for the second chroma component. Therefore, before the determining, based on the chroma value of the surrounding reconstructed region for the i^{th} chroma component, the limit range of the predicted value of the current chroma block for the i^{th} chroma component, the encoding end first determines a surrounding reconstructed region of the current chroma block for the i^{th} component, and records the surrounding reconstructed region as a first surrounding reconstructed region.

In embodiments of this application, a specific manner of determining the first surrounding reconstructed region of the current chroma block for the i^{th} component includes but is not limited to the following manners.

Manner 1: a default reconstructed region is determined as the first surrounding reconstructed region of the current chroma block for the i^{th} component. For example, an upper reconstructed region of the current chroma block, an upper-left reconstructed region of the current chroma block, and an upper-right reconstructed region of the current chroma block are used by default as the first surrounding reconstructed region of the current chroma block for the i^{th} component. For another example, an upper reconstructed region of the current chroma block, an upper-left reconstructed region of the current chroma block, an upper-right reconstructed region of the current chroma block, a left reconstructed region of the current chroma block, and a lower-left reconstructed region of the current chroma block are used by default as the first surrounding reconstructed region of the current chroma block for the i^{th} component.

For example, the first surrounding reconstructed region of the current chroma block for the Cb chroma component is as shown in FIG. 8A.

For example, the first surrounding reconstructed region of the current chroma block for the Cr chroma component is as shown in FIG. 8B.

Manner 2: In a case that the prediction mode of the current chroma block is a convolutional cross component model mode, a second surrounding reconstructed region corresponding to the convolutional cross component model mode is determined; and the first surrounding reconstructed region is determined based on the second surrounding reconstructed region.

In Manner 2, the encoding end determines the prediction mode of the current chroma block according to the foregoing steps. If the prediction mode of the current chroma block is a convolutional cross component model mode in the cross component intra prediction mode, it may be learned from the foregoing description that, a filter coefficient is required to be determined based on the surrounding reconstructed region of the current chroma block in the convolutional cross component model mode. In embodiments of this application, for ease of description, the surrounding reconstructed region of the current chroma block that is in the convolutional cross component model mode and that is used for determining the filter coefficient is referred to as the second surrounding reconstructed region. In this way, in a case that the prediction mode of the current chroma block is the convolutional cross component model mode, the encoding end determines the second surrounding reconstructed region corresponding to the convolutional cross component model mode, and determines the first surrounding reconstructed region based on the second surrounding reconstructed region.

In embodiments of this application, a specific shape of the second surrounding reconstructed region of the current chroma block is not limited.

In some embodiments, the second surrounding reconstructed region includes any one of a first type of reconstructed region, a second type of reconstructed region, or a third type of reconstructed region.

For example, as shown in FIG. 9A, the first type of reconstructed region includes an upper region, an upper-left region, an upper-right region, a left region, and a lower-left region of the current chroma block. In this case, a model parameter of the CCCM is derived from a surrounding region of the current chroma component and a surrounding region of a corresponding luma block.

For example, as shown in FIG. 9B, the second type of reconstructed region includes an upper region, an upper-left region, and an upper-right region of the current chroma block. In this case, a model parameter of the CCCM is derived from an upper region, an upper-left region, and an upper-right region of the current chroma block and an upper region, an upper-left region, and an upper-right region of the corresponding luma block.

For example, as shown in FIG. 9C, the third type of reconstructed region includes a left region, an upper-left region, and a lower-left region of the current chroma block. In this case, a model parameter of the CCCM is derived from a left region, an upper-left region, and a lower-left region of the current chroma block and a left region, an upper-left region, and a lower-left region of the corresponding luma block.

It should be noted that, in addition to the first type of reconstructed region, the second type of reconstructed region, and the third type of reconstructed region, the second surrounding reconstructed region in embodiments of this application may alternatively be another type of reconstructed region, which is not limited in embodiments of this application.

In some embodiments, if it is determined that the prediction mode of the current chroma block is a convolutional cross component model mode, the encoding end may determine a type of the second surrounding reconstructed region by encoding a related syntax element, that is, determine which type of reconstructed region of the current chroma block is used to derive the model parameter of the CCCM.

The encoding end determines the second surrounding reconstructed region corresponding to the convolutional cross component model mode, and determines the first surrounding reconstructed region based on the second surrounding reconstructed region.

In embodiments of this application, a specific manner in which the encoding end determines the first surrounding reconstructed region based on the second surrounding reconstructed region is not limited.

In some embodiments, a shape of the first surrounding reconstructed region is the same as a shape of the second surrounding reconstructed region.

Example 1: if the second surrounding reconstructed region is the first type of reconstructed region, it is determined that the first surrounding reconstructed region is also the first type of reconstructed region. For example, the second surrounding reconstructed region, as shown in FIG. 9A, includes an upper region, an upper-left region, an upper-right region, a left region, and a lower-left region of the current chroma block. In this case, a shape of the first surrounding reconstructed region is the same as a shape of the second surrounding reconstructed region. As shown in FIG. 10A, the first surrounding reconstructed region may also include an upper region, an upper-left region, an upper-right region, a left region, and a lower-left region of the current chroma block. Optionally, the first surrounding reconstructed region may include a quantity of rows and a quantity of columns the same as, or different from, or partially the same as and partially different from those included in the second surrounding reconstructed region (for example, the first surrounding reconstructed region includes a quantity of rows the same as that included in the second surrounding reconstructed region and a quantity of columns different from that included in the second surrounding reconstructed region, or the first surrounding reconstructed region includes a quantity of columns the same as that included in the second surrounding reconstructed region and a quantity of rows different from that included in the second surrounding reconstructed region), which is not limited in embodiments of this application.

Example 2: If the second surrounding reconstructed region is the second type of reconstructed region, it is determined that the first surrounding reconstructed region is the second type of reconstructed region. For example, if the second surrounding reconstructed region, as shown in FIG. 9B, includes an upper region, an upper-left region, and an upper-right region of the current chroma block, a shape of the first surrounding reconstructed region is the same as a shape of the second surrounding reconstructed region. As shown in FIG. 10B, the first surrounding reconstructed region may also include an upper region, an upper-left region, and an upper-right region of the current chroma block. Optionally, the first surrounding reconstructed region may include a quantity of rows the same as or different from that included in the second surrounding reconstructed region, which is not limited in embodiments of this application.

Example 3: If the second surrounding reconstructed region is the third type of reconstructed region, it is determined that the first surrounding reconstructed region is the third type of reconstructed region. For example, if the second surrounding reconstructed region, as shown in FIG. 9C, includes a left region, an upper-left region, and a lower-left region of the current chroma block, a shape of the first surrounding reconstructed region is the same as a shape of the second surrounding reconstructed region. As shown in FIG. 10C, the first surrounding reconstructed region may also include a left region, an upper-left region, and a lower-left region of the current chroma block. Optionally, the first surrounding reconstructed region may include a quantity of rows the same as or different from that included in the second surrounding reconstructed region, which is not limited in embodiments of this application.

In an example, when determining the model parameter of the CCCM based on the second surrounding reconstructed region, the encoding end may also determine the limit range of the predicted value of the current chroma block for the i^{th} chroma component by using the second surrounding reconstructed region. In this case, the first surrounding reconstructed region is the same as the second surrounding reconstructed region.

Manner 3: The first surrounding reconstructed region includes at least one of preset N types of reconstructed regions, where N is a positive integer.

In embodiments of this application, specific shapes of the N types of reconstructed regions are not limited.

In some embodiments, the preset N types of reconstructed regions include five types of reconstructed regions.

For example, the 1^{st} type of reconstructed region in the five types of reconstructed regions includes an upper region, an upper-left region, and a left region of the current chroma block. As shown in FIG. 11A, the 1^{st} type of reconstructed region of the current chroma block for the Cb chroma component includes an upper region, an upper-left region, and a left region of the current chroma block for the Cb chroma component. The 1^{st} type of reconstructed region of the current chroma block for the Cr chroma component includes an upper region, an upper-left region, and a left region of the current chroma block for the Cr chroma component.

For example, the 2^{nd} type of reconstructed region in the five types of reconstructed regions includes an upper region and an upper-right region of the current chroma block. As shown in FIG. 11B, the 2^{nd} type of reconstructed region of the current chroma block for the Cb chroma component includes an upper region and an upper-right region of the current chroma block for the Cb chroma component. The 2^{nd} type of reconstructed region of the current chroma block for the Cr chroma component includes an upper region and an upper-right region of the current chroma block for the Cr chroma component.

For example, the 3^{rd} type of reconstructed region in the five types of reconstructed regions includes an upper region of the current chroma block. As shown in FIG. 11C, the 3^{rd} type of reconstructed region of the current chroma block for the Cb chroma component includes an upper region of the current chroma block for the Cb chroma component. The 3^{rd} type of reconstructed region of the current chroma block for the Cr chroma component includes an upper region of the current chroma block for the Cr chroma component.

For example, the 4^{th} type of reconstructed region in the five types of reconstructed regions includes an upper-left region and a left region of the current chroma block. As shown in FIG. 11D, the 4^{th} type of reconstructed region of the current chroma block for the Cb chroma component includes an upper-left region and a left region of the current chroma block for the Cb chroma component. The 4^{th} type of reconstructed region of the current chroma block for the Cr chroma component includes an upper-left region and a left region of the current chroma block for the Cr chroma component.

For example, the 5^{th} type of reconstructed region in the five types of reconstructed regions includes a left region of the current chroma block. As shown in FIG. 11E, the 5^{th} type of reconstructed region of the current chroma block for the Cb chroma component includes a left region of the current chroma block for the Cb chroma component. The 5^{th} type of reconstructed region of the current chroma block for the Cr chroma component includes a left region of the current chroma block for the Cr chroma component.

That is, in Manner 3, the encoding end may use any one or more types of reconstructed regions among the N types of reconstructed regions as the first surrounding reconstructed region.

For example, each type of reconstructed region in the N types of reconstructed regions includes at least one row and/or at least one column of reconstructed pixel values. Optionally, six rows and/or six columns of reconstructed pixel values the same as those used in the CCCM and GLM modes may be used.

After determining the first surrounding reconstructed region of the current chroma block for the i^{th} component according to the foregoing method, the encoding end determines the limit range of the predicted value of the current chroma block for the i^{th} chroma component based on the first surrounding reconstructed region.

In embodiments of this application, a specific manner in which the encoding end determines the limit range of the predicted value of the current chroma block for the i^{th} chroma component based on the first surrounding reconstructed region is not limited.

For example, if the limit range of the predicted value of the current chroma block for the i^{th} chroma component includes the maximum limit value of the predicted value of the current chroma block for the i^{th} chroma component, the encoding end determines that a maximum chroma value of the surrounding reconstructed region for the i^{th} chroma component is the maximum limit value of the predicted value of the current chroma block for the i^{th} chroma component.

For another example, if the limit range of the predicted value of the current chroma block for the i^{th} chroma component includes the minimum limit value of the predicted value of the current chroma block for the i^{th} chroma component, the encoding end determines that a minimum chroma value of the surrounding reconstructed region for the i^{th} chroma component is the minimum limit value of the predicted value of the current chroma block for the i^{th} chroma component.

For another example, if the limit range of the predicted value of the current chroma block for the i^{th} chroma component includes the maximum limit value and the minimum limit value of the predicted value of the current chroma block for the i^{th} chroma component, the encoding end determines that a maximum chroma value of the surrounding reconstructed region for the i^{th} chroma component is the maximum limit value of the predicted value of the current chroma block for the i^{th} chroma component, and determines that a minimum chroma value of the surrounding reconstructed region for the i^{th} chroma component is the minimum limit value of the predicted value of the current chroma block for the i^{th} chroma component.

For another example, if the limit range of the predicted value of the current chroma block for the i^{th} chroma component includes the maximum limit value of the predicted value of the current chroma block for the i^{th} chroma component, the encoding end determines that an average value of a plurality of maximum chroma values of the surrounding reconstructed region for the i^{th} chroma component is the maximum limit value of the current chroma block for the i^{th} chroma component.

For another example, if the limit range of the predicted value of the current chroma block for the i^{th} chroma component includes the minimum limit value of the predicted value of the current chroma block for the i^{th} chroma component, the encoding end determines that an average value of a plurality of minimum chroma values of the surrounding reconstructed region for the i^{th} chroma component is the minimum limit value of the predicted value of the current chroma block for the i^{th} chroma component.

For another example, if the limit range of the predicted value of the current chroma block for the i^{th} chroma component includes the maximum limit value and the minimum limit value of the predicted value of the current chroma block for the i^{th} chroma component, the encoding end determines that an average value of a plurality of maximum chroma values of the surrounding reconstructed region for the i^{th} chroma component is the maximum limit value of the predicted value of the current chroma block for the i^{th} chroma component, and determines that an average value of a plurality of minimum chroma values of the surrounding reconstructed region for the i^{th} chroma component is the minimum limit value of the predicted value of the current chroma block for the i^{th} chroma component.

In the foregoing embodiment, a specific process in which the encoding end determines the limit range of the predicted value of the current chroma block is described.

In S203, a first predicted value of the current chroma block is determined based on the cross component intra prediction mode.

It should be noted that, the steps of determining the limit range of the predicted value of the current chroma block in S203 and S202 are not performed in strict order. That is, if it is determined that the prediction mode of the current chroma block is the cross component intra prediction mode, the encoding end may first perform S203 of determining a first predicted value of the current chroma block, and then perform S202 of determining the limit range of the predicted value of the current chroma block. Alternatively, the encoding end may first perform S202 of determining the limit range of the predicted value of the current chroma block, and then perform S203 of determining a first predicted value of the current chroma block based on the cross component intra prediction mode. Alternatively, the encoding end may simultaneously perform S203 of determining a first predicted value of the current chroma block based on the cross component intra prediction mode and S202 of determining the limit range of the predicted value of the current chroma block. A performing order of S202 and S203 is determined depending on an actual situation, and is not limited in embodiments of this application.

In embodiments of this application, for ease of description, the predicted value of the current chroma block obtained based on the cross component intra prediction mode is referred to as the first predicted value of the current chroma block.

In embodiments of this application, a specific manner of determining the first predicted value of the current chroma block varies depending on a cross component intra prediction mode used for the current chroma block.

In some embodiments, if the cross component intra prediction mode used for the current chroma block is the CCCM mode, the encoding end determines a first preset value of the current chroma block according to the formula (7).

In some embodiments, if the cross component intra prediction mode used for the current chroma block is the GLM mode, the encoding end determines a first preset value of the current chroma block according to the formula (8) or the formula (9).

In some embodiments, the encoding end determines a first predicted value of the current chroma block for each of the two chroma components. That is, for the i^{th} chroma component of the current chroma block, the encoding end determines the first predicted value of the current chroma block for the i^{th} chroma component based on the cross component intra prediction mode. For example, the encoding end determines the first predicted value of the current chroma block for the first chroma component (the Cb or U component) based on the cross component intra prediction mode, and the encoding end determines the first predicted value of the current chroma block for the second chroma component (the Cr or V component) based on the cross component intra prediction mode.

The encoding end determines the limit range of the predicted value of the current chroma block according to S202, and determines the first predicted value of the current chroma block according to S203. Next, the following step S204 is performed.

In S204, a second predicted value of the current chroma block is determined based on the first predicted value and the limit range.

In embodiments of this application, if the prediction mode of the current chroma block is a cross component intra prediction mode, the limit range of the predicted value of the current chroma block is determined to improve prediction performance. Then, the first predicted value determined based on the cross component intra prediction mode is limited based on the limit range, thereby preventing the first predicted value obtained based on the cross component intra prediction mode from being excessively large or small, thus improving prediction accuracy of the current chroma block and enhancing encoding performance.

In embodiments of this application, a specific manner in which the encoding end determines a second predicted value of the current chroma block based on the first predicted value and the limit range is not limited.

In some embodiments, it is assumed that the predicted values for the first chroma component and the second chroma component correspond to a same limit range. For example, if the first chroma component and the second chroma component correspond to a maximum limit value a, the maximum limit value a is used to limit the first predicted value of the current chroma block for the first chroma component and the first predicted value of the current chroma block for the second chroma component. If the first chroma component and the second chroma component correspond to a minimum limit value b, the minimum limit value b is used to limit the first predicted value of the current chroma block for the first chroma component and the first predicted value of the current chroma block for the second chroma component.

For example, if the first predicted value of the current chroma block for the first chroma component is less than the maximum limit value a, the first predicted value of the current chroma block for the first chroma component is determined as the second predicted value of the current chroma block for the first chroma component. If the first predicted value of the current chroma block for the first chroma component is greater than the maximum limit value a, the maximum limit value a is determined as the second predicted value of the current chroma block for the first chroma component. If the first predicted value of the current chroma block for the second chroma component is less than the maximum limit value a, the first predicted value of the current chroma block for the second chroma component is determined as the second predicted value of the current chroma block for the second chroma component. If the first predicted value of the current chroma block for the second chroma component is greater than the maximum limit value a, the maximum limit value a is determined as the second predicted value of the current chroma block for the second chroma component.

For another example, if the first predicted value of the current chroma block for the first chroma component is greater than the minimum limit value b, the first predicted value of the current chroma block for the first chroma component is determined as the second predicted value of the current chroma block for the first chroma component. If the first predicted value of the current chroma block for the first chroma component is less than the minimum limit value b, the minimum limit value b is determined as the second predicted value of the current chroma block for the first chroma component. If the first predicted value of the current chroma block for the second chroma component is greater than the minimum limit value b, the first predicted value of the current chroma block for the second chroma component is determined as the second predicted value of the current chroma block for the second chroma component. If the first predicted value of the current chroma block for the second chroma component is less than the minimum limit value b, the minimum limit value b is determined as the second predicted value of the current chroma block for the second chroma component.

In some embodiments, predicted values for the first chroma component and the second chroma component correspond to a same limit range. An i^{th} chroma component is used as an example. In this case, the encoding end may determine the second predicted value of the current chroma block for the i^{th} chroma component based on the first predicted value for the i^{th} chroma component and the limit range for the i^{th} chroma component.

In an example, if the limit range for the i^{th} chroma component includes a maximum limit value, the maximum limit value for the i^{th} chroma component is used to limit the first predicted value of the current chroma block for the i^{th} chroma component.

For example, if the first predicted value of the current chroma block for the i^{th} chroma component is less than or equal to the maximum limit value for the i^{th} chroma component, the first predicted value of the current chroma block for the i^{th} chroma component is determined as the second predicted value of the current chroma block for the i^{th} chroma component.

For another example, if the first predicted value of the current chroma block for the i^{th} chroma component is greater than the maximum limit value for the i^{th} chroma component, the maximum limit value for the i^{th} chroma component is determined as the second predicted value of the current chroma block for the i^{th} chroma component.

In an example, if the limit range for the i^{th} chroma component includes a minimum limit value, the minimum limit value for the i^{th} chroma component is used to limit the first predicted value of the current chroma block for the i^{th} chroma component.

For example, if the first predicted value of the current chroma block for the i^{th} chroma component is greater than or equal to the minimum limit value for the i^{th} chroma component, the first predicted value of the current chroma block for the i^{th} chroma component is determined as the second predicted value of the current chroma block for the i^{th} chroma component.

For another example, if the first predicted value of the current chroma block for the i^{th} chroma component is less than the minimum limit value for the i^{th} chroma component, the minimum limit value for the i^{th} chroma component is determined as the second predicted value of the current chroma block for the i^{th} chroma component.

In an example, if the limit range for the i^{th} chroma component includes a maximum limit value and a minimum limit value, the maximum limit value and the minimum limit value for the i^{th} chroma component are used to limit the first predicted value of the current chroma block for the i^{th} chroma component.

For example, if the first predicted value of the current chroma block for the i^{th} chroma component is less than or equal to the maximum limit value for the i^{th} chroma component and greater than or equal to the minimum limit value for the i^{th} chroma component, the first predicted value of the current chroma block for the i^{th} chroma component is determined as the second predicted value of the current chroma block for the i^{th} chroma component.

For another example, if the first predicted value of the current chroma block for the i^{th} chroma component is greater than the maximum limit value for the i^{th} chroma component, the maximum limit value for the i^{th} chroma component is determined as the second predicted value of the current chroma block for the i^{th} chroma component.

For another example, if the first predicted value of the current chroma block for the i^{th} chroma component is less than the minimum limit value for the i^{th} chroma component, the minimum limit value for the i^{th} chroma component is determined as the second predicted value of the current chroma block for the i^{th} chroma component.

In embodiments of this application, the predicted value of the current chroma block is determined on a per-pixel basis. That is, the encoding end predicts a predicted value of each pixel in the current chroma block to obtain a first predicted value of each pixel, and limits the first predicted value of each pixel to obtain a second predicted value of each pixel. A process in which the encoding end obtains the second predicted values of different pixels by limiting the first predicted values of respective pixels in the current chroma block is identical. Herein, a current location (x, y) within the current chroma block is used as an example for description.

For example, for the current location (x, y) within the current chroma block, a process of limiting a Cb predicted value and a Cr predicted value of the current location (x, y) is shown in Table 2.

According to Table 2, if the Cb predicted value (that is, the first predicted value for the Cb component) of the current location (x, y) within the current chroma block that is determined based on the cross component intra prediction mode is greater than a maximum limit value max cb for the Cb component, max_{cb} is determined as the Cb predicted value (that is, the second predicted value) of the current location (x, y). If the Cb predicted value (that is, the first predicted value for the Cb component) of the current location (x, y) that is determined based on the cross component intra prediction mode is less than a minimum limit value min_{cb} for the Cb component, min_{cb} is determined as the Cb predicted value (that is, the second predicted value) of the current location (x, y). Similarly, if the Cr predicted value (that is, the first predicted value for the Cr component) of the current location (x, y) within the current chroma block that is determined based on the cross component intra prediction mode is greater than a maximum limit value max_{cr} for the Cr component, max_{cr} is determined as the Cr predicted value (that is, the second predicted value) of the current location (x, y). If the Cr predicted value (that is, the first predicted value for the Cr component) of the current location (x, y) that is determined based on the cross component intra prediction mode is less than a minimum limit value min_{cr} for the Cr component, min_{cr} is determined as the Cr predicted value (that is, the second predicted value) of the current location (x, y).

The encoding end may determine the second predicted value of the current chroma block according to the foregoing steps, and may further encode the current chroma block based on the second predicted value to obtain a bitstream.

According to the video encoding method provided in embodiments of this application, a prediction mode of a current chroma block is determined when predicting the current chroma block; in a case that the prediction mode is a cross component intra prediction mode, a limit range of a predicted value of the current chroma block is determined, where the limit range includes at least one of a maximum limit value or a minimum limit value of the predicted value; next, a first predicted value of the current chroma block is determined based on the cross component intra prediction mode; and a second predicted value of the current chroma block is determined based on the first predicted value and the limit range. That is, in embodiments of this application, in a case that the cross component intra prediction mode is used for the current chroma block, the first predicted value determined based on the cross component intra prediction mode is limited, thereby preventing the predicted value of the current chroma block from being excessively large or small, thus improving prediction accuracy of the current chroma block and enhancing video coding performance.

It should be understood that FIG. 7 to FIG. 12 are merely examples of this application, and should not be construed as a limitation to this application.

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application.

It should be further understood that, in the method embodiments of this application, sequence numbers of the foregoing processes do not mean execution sequences. The execution sequences of the processes shall be determined based on functions and internal logic of the processes, and shall not be construed as any limitation on the implementation processes of embodiments of this application. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in this application generally indicates an “or” relationship between the associated objects.

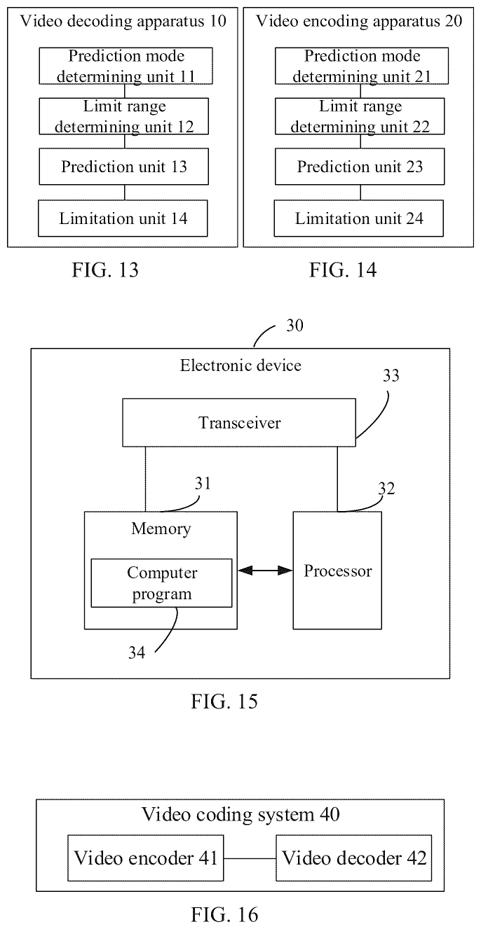

The foregoing describes the method embodiments of this application in detail with reference to FIG. 7 to FIG. 12. The following describes the apparatus embodiments of this application in detail with reference to FIG. 13 to FIG. 15.

FIG. 13 is a schematic block diagram of a video decoding apparatus according to an embodiment of this application. The video decoding apparatus 10 is applied to the video decoder described above.

As shown in FIG. 13, the video decoding apparatus 10 includes:
a prediction mode determining unit 11, configured to determine a prediction mode of a current chroma block;
a limit range determining unit 12, configured to: in a case that the prediction mode is a cross component intra prediction mode, determine a limit range of a predicted value of the current chroma block based on a chroma value of a surrounding reconstructed region of the current chroma block, where the limit range includes at least one of a maximum limit value or a minimum limit value of the predicted value;
a prediction unit 13, configured to determine a first predicted value of the current chroma block based on the cross component intra prediction mode; and
a limitation unit 14, configured to determine a second predicted value of the current chroma block based on the first predicted value and the limit range.

In some embodiments, the prediction mode determining unit 11 is specifically configured to decode a bitstream to obtain the prediction mode of the current chroma block.

In some embodiments, the prediction mode determining unit 11 is specifically configured to decode the bitstream to obtain a first prediction mode; and determine the prediction mode of the current chroma block based on the first prediction mode.

In some embodiments, the prediction mode determining unit 11 is specifically configured to: in a case that the first prediction mode is a convolutional cross component model mode or a gradient linear model mode, determine the convolutional cross component model mode or the gradient linear model mode as the prediction mode of the current chroma block.

In some embodiments, the prediction mode determining unit 11 is specifically configured to: in a case that the first prediction mode is a cross component merge mode, construct a cross component prediction mode list by inheriting a cross component intra prediction mode of a chroma block surrounding the current chroma block that is adjacent and/or non-adjacent to the current chroma block; and determine the prediction mode of the current chroma block based on the cross component prediction mode list.

In some embodiments, the prediction mode determining unit 11 is specifically configured to decode the bitstream to obtain a mode index; and determine the prediction mode of the current chroma block from the cross component prediction mode list based on the mode index.

In some embodiments, before the determining the limit range of the predicted value of the current chroma block, the limit range determining unit 12 is further configured to: determine a first flag corresponding to the current chroma block, where the first flag is used to indicate whether to limit the predicted value of the current chroma block; and in a case that the first flag indicates that the predicted value of the current chroma block is to be limited, determine the limit range of the predicted value of the current chroma block.

In some embodiments, the limit range determining unit 12 is specifically configured to: in a case that a first prediction mode obtained by decoding a bitstream is a cross component merge mode, determine a chroma block corresponding to a prediction mode inherited by the current chroma block; and determine a first flag corresponding to the chroma block as the first flag corresponding to the current chroma block.

In some embodiments, the limit range determining unit 12 is specifically configured to decode a bitstream to obtain the first flag corresponding to the current chroma block.

In some embodiments, before the determining the limit range of the predicted value of the current chroma block, the limit range determining unit 12 is further configured to: determine whether the current chroma block meets a preset condition; and in a case that the current chroma block meets the preset condition, determine the limit range of the predicted value of the current chroma block.

In some embodiments, the preset condition includes at least one of the following:
the current chroma block is not a first-row chroma block of a current CTU;
a size of the current chroma block meets a preset size; or
a shape of the current chroma block meets a preset shape.

In some embodiments, the limit range determining unit 12 is specifically configured to determine a chroma block corresponding to a prediction mode inherited by the current chroma block; and determine a limit range of a predicted value of the chroma block as the limit range of the predicted value of the current chroma block.

In some embodiments, the limit range determining unit 12 is specifically configured to determine the limit range of the predicted value of the current chroma block based on the chroma value of the surrounding reconstructed region of the current chroma block.

In some embodiments, the limit range determining unit 12 is specifically configured to determine, based on a chroma value of the surrounding reconstructed region for an i^{th} chroma component, a limit range of a predicted value of the current chroma block for the i^{th} chroma component, where i is a positive integer.

The prediction unit 13 is specifically configured to determine a first predicted value of the current chroma block for the i^{th} chroma component based on the cross component intra prediction mode.

The limitation unit 14 is specifically configured to determine a second predicted value of the current chroma block for the i^{th} chroma component based on the first predicted value for the i^{th} chroma component and the limit range for the i^{th} chroma component.

In some embodiments, before the determining, based on the chroma value of the surrounding reconstructed region for the i^{th} chroma component, the limit range of the predicted value of the current chroma block for the i^{th} chroma component, the limit range determining unit 12 is further configured to determine a first surrounding reconstructed region of the current chroma block for the i^{th} component; and determine the limit range of the predicted value of the current chroma block for the i^{th} chroma component based on the first surrounding reconstructed region.

In some embodiments, the limit range determining unit 12 is specifically configured to: in a case that the prediction mode of the current chroma block is a convolutional cross component model mode, determine a second surrounding reconstructed region corresponding to the convolutional cross component model mode; and determine the first surrounding reconstructed region based on the second surrounding reconstructed region.

In some embodiments, the second surrounding reconstructed region includes any one of a first type of reconstructed region, a second type of reconstructed region, or a third type of reconstructed region; the first type of reconstructed region includes an upper region, an upper-left region, an upper-right region, a left region, and a lower-left region of the current chroma block; the second type of reconstructed region includes an upper region, an upper-left region, and an upper-right region of the current chroma block; and the third type of reconstructed region includes a left region, an upper-left region, and a lower-left region of the current chroma block.

In some embodiments, the limit range determining unit 12 is specifically configured to: in a case that the second surrounding reconstructed region is the second type of reconstructed region, determine that the first surrounding reconstructed region is the second type of reconstructed region; or in a case that the second surrounding reconstructed region is the third type of reconstructed region, determine that the first surrounding reconstructed region is the third type of reconstructed region.

In some embodiments, the first surrounding reconstructed region includes at least one of preset N types of reconstructed regions, where N is a positive integer.

In some embodiments, the N types of reconstructed regions include five types of reconstructed regions, where the 1^{st} type of reconstructed region includes an upper region, an upper-left region, and a left region of the current chroma block; the 2^{nd} type of reconstructed region includes an upper region and an upper-right region of the current chroma block; the 3^{rd} type of reconstructed region includes an upper region of the current chroma block; the 4^{th} type of reconstructed region includes an upper-left region and a left region of the current chroma block; and the 5^{th} type of reconstructed region includes a left region of the current chroma block.

In some embodiments, the limit range determining unit 12 is specifically configured to determine that a maximum chroma value of the surrounding reconstructed region for the i^{th} chroma component is a maximum limit value of a predicted value of the current chroma block for the i^{th} chroma component; and/or determine that a minimum chroma value of the surrounding reconstructed region for the i^{th} chroma component is a minimum limit value of a predicted value of the current chroma block for the i^{th} chroma component.

In some embodiments, the limit range includes the maximum limit value. The limitation unit 14 is specifically configured to: in a case that the first predicted value is less than or equal to the maximum limit value, determine the first predicted value as the second predicted value; and in a case that the first predicted value is greater than the maximum limit value, determine the maximum limit value as the second predicted value.

In some embodiments, the limit range includes the minimum limit value. The limitation unit 14 is specifically configured to: in a case that the first predicted value is greater than the minimum limit value, determine the first predicted value as the second predicted value; and in a case that the first predicted value is less than the minimum limit value, determine the minimum limit value as the second predicted value.

In some embodiments, the limit range includes the minimum limit value and the maximum limit value. The limitation unit 14 is specifically configured to: in a case that the first predicted value is less than or equal to the maximum limit value and greater than or equal to the minimum limit value, determine the first predicted value as the second predicted value; in a case that the first predicted value is greater than the maximum limit value, determine the maximum limit value as the second predicted value; and in a case that the first predicted value is less than the minimum limit value, determine the minimum limit value as the second predicted value.

It should be understood that the apparatus embodiments may correspond to the method embodiments, and for similar descriptions, reference may be made to the method embodiments. To avoid repetition, details are not described herein again. Specifically, the apparatus 10 shown in FIG. 13 may perform the decoding method at the decoding end provided in embodiments of this application, and the foregoing and other operations and/or functions of the units in the apparatus 10 are respectively intended to implement corresponding procedures in various methods of the decoding method at the decoding end. For brevity, details are not described herein.

FIG. 14 is a schematic block diagram of a video encoding apparatus according to an embodiment of this application. The video encoding apparatus is applied to the encoder described above.

As shown in FIG. 14, the video encoding apparatus 20 includes:
a prediction mode determining unit 21, configured to determine a prediction mode of a current chroma block;
a limit range determining unit 22, configured to: in a case that the prediction mode is a cross component intra prediction mode, determine a limit range of a predicted value of the current chroma block based on a chroma value of a surrounding reconstructed region of the current chroma block, where the limit range includes at least one of a maximum limit value or a minimum limit value of the predicted value;
a prediction unit 23, configured to determine a first predicted value of the current chroma block based on the cross component intra prediction mode; and
a limitation unit 24, configured to determine a second predicted value of the current chroma block based on the first predicted value and the limit range.

In some embodiments, the prediction mode determining unit 21 is specifically configured to determine a first prediction mode; and determine the prediction mode of the current chroma block based on the first prediction mode.

In some embodiments, the prediction mode determining unit 21 is specifically configured to: in a case that the first prediction mode is a convolutional cross component model mode or a gradient linear model mode, determine the convolutional cross component model mode or the gradient linear model mode as the prediction mode of the current chroma block.

In some embodiments, the prediction mode determining unit 21 is specifically configured to: in a case that the first prediction mode is a cross component merge mode, construct a cross component prediction mode list by inheriting a cross component intra prediction mode of a chroma block surrounding the current chroma block that is adjacent and/or non-adjacent to the current chroma block; and determine the prediction mode of the current chroma block based on the cross component prediction mode list.

In some embodiments, the prediction mode determining unit 21 is further configured to write a mode index of the prediction mode of the current chroma block in the cross component prediction mode list into a bitstream.

In some embodiments, the prediction mode determining unit 21 is further configured to write the prediction mode of the current chroma block into a bitstream.

In some embodiments, before the determining the limit range of the predicted value of the current chroma block, the limit range determining unit 22 is further configured to: determine a first flag corresponding to the current chroma block, where the first flag is used to indicate whether to limit the predicted value of the current chroma block; and in a case that the first flag indicates that the predicted value of the current chroma block is to be limited, determine the limit range of the predicted value of the current chroma block.

In some embodiments, the limit range determining unit 22 is specifically configured to: determine a first prediction mode; in a case that the first prediction mode is a cross component merge mode, determine a chroma block corresponding to a prediction mode inherited by the current chroma block; and determine a first flag corresponding to the chroma block as the first flag corresponding to the current chroma block.

In some embodiments, the limit range determining unit 22 is further configured to write the first flag corresponding to the current chroma block into a bitstream.

In some embodiments, before the determining the limit range of the predicted value of the current chroma block, the limit range determining unit 22 is further configured to determine whether the current chroma block meets a preset condition; and in a case that the current chroma block meets the preset condition, determine the limit range of the predicted value of the current chroma block.

In some embodiments, the preset condition includes at least one of the following:
the current chroma block is not a first-row chroma block of a current CTU;
a size of the current chroma block meets a preset size; or
a shape of the current chroma block meets a preset shape.

In some embodiments, the limit range determining unit 22 is specifically configured to determine a chroma block corresponding to a prediction mode inherited by the current chroma block; and determine a limit range of a predicted value of the chroma block as the limit range of the predicted value of the current chroma block.

In some embodiments, the limit range determining unit 22 is specifically configured to determine the limit range of the predicted value of the current chroma block based on the chroma value of the surrounding reconstructed region of the current chroma block.

In some embodiments, the limit range determining unit 22 is specifically configured to determine, based on a chroma value of the surrounding reconstructed region for an i^{th} chroma component, a limit range of a predicted value of the current chroma block for the i^{th} chroma component, where i is a positive integer.

The prediction unit 23 is specifically configured to determine a first predicted value of the current chroma block for the i^{th} chroma component based on the cross component intra prediction mode.

The limitation unit 24 is specifically configured to determine a second predicted value of the current chroma block for the i^{th} chroma component based on the first predicted value for the i^{th} chroma component and the limit range for the i^{th} chroma component.

In some embodiments, before the determining, based on the chroma value of the surrounding reconstructed region for the i^{th} chroma component, the limit range of the predicted value of the current chroma block for the i^{th} chroma component, the limit range determining unit 22 is further configured to determine a first surrounding reconstructed region of the current chroma block for the i^{th} component; and determine the limit range of the predicted value of the current chroma block for the i^{th} chroma component based on the first surrounding reconstructed region.

In some embodiments, the limit range determining unit 22 is specifically configured to: in a case that the prediction mode of the current chroma block is a convolutional cross component model mode, determine a second surrounding reconstructed region corresponding to the convolutional cross component model mode; and determine the first surrounding reconstructed region based on the second surrounding reconstructed region.

In some embodiments, the second surrounding reconstructed region includes any one of a first type of reconstructed region, a second type of reconstructed region, or a third type of reconstructed region. The first type of reconstructed region includes an upper region, an upper-left region, an upper-right region, a left region, and a lower-left region of the current chroma block; the second type of reconstructed region includes an upper region, an upper-left region, and an upper-right region of the current chroma block; and the third type of reconstructed region includes a left region, an upper-left region, and a lower-left region of the current chroma block.

In some embodiments, the limit range determining unit 22 is specifically configured to: in a case that the second surrounding reconstructed region is the second type of reconstructed region, determine that the first surrounding reconstructed region is the second type of reconstructed region; or in a case that the second surrounding reconstructed region is the third type of reconstructed region, determine that the first surrounding reconstructed region is the third type of reconstructed region.

In some embodiments, the first surrounding reconstructed region includes at least one of preset N types of reconstructed regions, where N is a positive integer.

In some embodiments, the N types of reconstructed regions include five types of reconstructed regions, where the 1^{st} type of reconstructed region includes an upper region, an upper-left region, and a left region of the current chroma block; the 2^{nd} type of reconstructed region includes an upper region and an upper-right region of the current chroma block; the 3^{rd} type of reconstructed region includes an upper region of the current chroma block; the 4^{th} type of reconstructed region includes an upper-left region and a left region of the current chroma block; and the 5^{th} type of reconstructed region includes a left region of the current chroma block.

In some embodiments, the limit range determining unit 22 is specifically configured to determine that a maximum chroma value of the surrounding reconstructed region for the i^{th} chroma component is a maximum limit value of a predicted value of the current chroma block for the i^{th} chroma component; and/or determine that a minimum chroma value of the surrounding reconstructed region for the i^{th} chroma component is a minimum limit value of a predicted value of the current chroma block for the i^{th} chroma component.

In some embodiments, the limit range includes the maximum limit value. The limitation unit 24 is specifically configured to: in a case that the first predicted value is less than or equal to the maximum limit value, determine the first predicted value as the second predicted value; and in a case that the first predicted value is greater than the maximum limit value, determine the maximum limit value as the second predicted value.

In some embodiments, the limit range includes the minimum limit value. The limitation unit 24 is specifically configured to: in a case that the first predicted value is greater than the minimum limit value, determine the first predicted value as the second predicted value; and in a case that the first predicted value is less than the minimum limit value, determine the minimum limit value as the second predicted value.

In some embodiments, the limit range includes the minimum limit value and the maximum limit value. The limitation unit 24 is specifically configured to: in a case that the first predicted value is less than or equal to the maximum limit value and greater than or equal to the minimum limit value, determine the first predicted value as the second predicted value; in a case that the first predicted value is greater than the maximum limit value, determine the maximum limit value as the second predicted value; and in a case that the first predicted value is less than the minimum limit value, determine the minimum limit value as the second predicted value.

It should be understood that the apparatus embodiments may correspond to the method embodiments, and for similar descriptions, reference may be made to the method embodiments. To avoid repetition, details are not described herein again. Specifically, the apparatus 20 shown in FIG. 14 may correspond to a performing body that performs the encoding method at the encoding end provided in embodiments of this application, and the foregoing and other operations and/or functions of the units in the apparatus 20 are respectively intended to implement corresponding procedures in various methods of the encoding method at the encoding end. For brevity, details are not described herein.

The apparatus and system in embodiments of this application are described above from a perspective of a functional unit with reference to the accompanying drawings. It should be understood that, the functional unit may be implemented in a hardware form, may be implemented by using instructions in a software form, or may be implemented by using a combination of hardware and a software unit. Specifically, the steps in the method embodiments in embodiments of this application may be completed by using an integrated logic circuit of hardware in a processor and/or instructions in a software form. The steps in the methods disclosed with reference to embodiments of this application may be directly performed by a hardware decoding processor, or may be performed by using a combination of hardware in the decoding processor and a software unit. Optionally, the software unit may be located in a mature storage medium in the art, such as a random access memory, a flash memory, a read-only memory, a programmable read-only memory, an electrically erasable programmable memory, or a register. The storage medium is located in a memory. The processor reads information from the memory, and performs the steps in the foregoing method embodiments in combination with hardware in the processor.

FIG. 15 is a schematic block diagram of an electronic device according to an embodiment of this application.

As shown in FIG. 15, the electronic device 30 may be the video encoder or the video decoder in embodiments of this application. The electronic device 30 may include:

a memory 33 and a processor 32, where the memory 33 is configured to store a computer program 34 and transmit the program code 34 to the processor 32. In other words, the processor 32 may invoke the computer program 34 from the memory 33 and run the computer program to implement a method in embodiments of this application.

For example, the processor 32 may be configured to perform the steps of the method 200 according to instructions in the computer program 34.

In some embodiments of this application, the processor 32 may include but is not limited to:
a general-purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logic device, a discrete gate or a transistor logic device, or a discrete hardware component.

In some embodiments of this application, the memory 33 includes but is not limited to:
a volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitation, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DR RAM).

In some embodiments of this application, the computer program 34 may be divided into one or more units. The one or more units are stored in the memory 33 and executed by the processor 32 to accomplish the methods provided in this application. The one or more units may be a series of computer program instruction segments capable of completing specific functions, the instruction segments are used to describe an execution process of the computer program 34 in the electronic device 30.

As shown in FIG. 15, the electronic device 30 may further include:
a transceiver 33, where the transceiver 33 may be connected to the processor 32 or the memory 33.

The processor 32 may control the transceiver 33 to communicate with another device. Specifically, the processor 32 may transmit information or data to the another device, or receive information or data transmitted by the another device. The transceiver 33 may include a transmitter and a receiver. The transceiver 33 may further include an antenna, and there may be one or more antennas.

It should be understood that the components in the electronic device 30 are connected by using a bus system. In addition to a data bus, the bus system further includes a power bus, a control bus, and a status signal bus.

FIG. 16 is a schematic block diagram of a video coding system according to an embodiment of this application.

As shown in FIG. 16, the video coding system 40 may include a video encoder 41 and a video decoder 42, where the video encoder 41 is configured to execute the video encoding method in embodiments of this application, and the video decoder 42 is configured to execute the video decoding method in embodiments of this application.

This application further provides a computer storage medium, where a computer program is stored in the computer storage medium. The computer program, when executed by a computer, causes the computer to execute the method in the foregoing method embodiments. Alternatively, an embodiment of this application further provides a computer program product including instructions. The instructions, when executed by a computer, causes the computer to execute the method in the foregoing method embodiments.

This application further provides a bitstream. The bitstream is generated according to the foregoing encoding method.

When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any available medium accessible by the computer, or a data storage device, such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state disk, SSD)), or the like.

Those of ordinary skill in the art may be aware that units and algorithm steps in examples described with reference to the embodiments disclosed in this application can be implemented by electronic hardware or a combination of computer software and electronic hardware. Whether the functions are executed by hardware or software depends on particular applications and design constraints of the technical solutions. A person skilled in the art may use different methods to implement the described functions for each specific application, but it should not be considered that the implementation goes beyond the scope of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may be or may not be physically separate, and parts displayed as units may be or may not be physical units, that is, may be located at one position, or may be distributed on a plurality of network units. A part or all of the units may be selected based on actual requirements to achieve the objectives of the solutions of embodiments. For example, functional units in embodiments of this application may be integrated into one processing unit, or each of the units may exist alone physically, or two or more units may be integrated into one unit.

The foregoing content are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A video decoding method, comprising:
determining a prediction mode of a current chroma block;
in a case that the prediction mode is a cross component intra prediction mode, determining a limit range of a predicted value of the current chroma block based on a chroma value of a surrounding reconstructed region of the current chroma block, wherein the limit range comprises at least one of a maximum limit value or a minimum limit value of the predicted value;
determining a first predicted value of the current chroma block based on the cross component intra prediction mode; and
determining a second predicted value of the current chroma block based on the first predicted value and the limit range.

2. The method according to claim 1, wherein the determining the prediction mode of the current chroma block comprises:
decoding a bitstream to obtain the prediction mode of the current chroma block.

3. The method according to claim 2, wherein the decoding the bitstream to obtain the prediction mode of the current chroma block comprises:
decoding the bitstream to obtain a first prediction mode; and
determining the prediction mode of the current chroma block based on the first prediction mode.

4. The method according to claim 3, wherein the determining the prediction mode of the current chroma block based on the first prediction mode comprises:
in a case that the first prediction mode is a convolutional cross component model mode or a gradient linear model mode, determining the convolutional cross component model mode or the gradient linear model mode as the prediction mode of the current chroma block.

5. The method according to claim 3, wherein the determining the prediction mode of the current chroma block based on the first prediction mode comprises:
in a case that the first prediction mode is a cross component merge mode, constructing a cross component prediction mode list by inheriting a cross component intra prediction mode of a chroma block surrounding the current chroma block that is adjacent and/or non-adjacent to the current chroma block; and
determining the prediction mode of the current chroma block based on the cross component prediction mode list.

6. The method according to claim 5, wherein the determining the prediction mode of the current chroma block based on the cross component prediction mode list comprises:
decoding the bitstream to obtain a mode index; and
determining the prediction mode of the current chroma block from the cross component prediction mode list based on the mode index.

7. The method according to claim 1, wherein before the determining the limit range of the predicted value of the current chroma block, the method further comprises:
determining whether the current chroma block meets a preset condition;
wherein the determining the limit range of the predicted value of the current chroma block comprises:
in a case that the current chroma block meets the preset condition, determining the limit range of the predicted value of the current chroma block.

8. The method according to claim 7, wherein the preset condition comprises at least one of following:
the current chroma block is not a first-row chroma block of a current CTU;
a size of the current chroma block meets a preset size; or
a shape of the current chroma block meets a preset shape.

9. The method according to claim 5, wherein the determining the limit range of the predicted value of the current chroma block comprises:
determining a chroma block corresponding to a prediction mode inherited by the current chroma block; and
determining a limit range of a predicted value of the chroma block as the limit range of the predicted value of the current chroma block.

10. The method according to claim 1, wherein the determining the limit range of the predicted value of the current chroma block comprises:
determining the limit range of the predicted value of the current chroma block based on the chroma value of the surrounding reconstructed region of the current chroma block.

11. The method according to claim 10, wherein the determining the limit range of the predicted value of the current chroma block based on the chroma value of the surrounding reconstructed region of the current chroma block comprises: determining, based on a chroma value of the surrounding reconstructed region for an i^{th} chroma component, a limit range of a predicted value of the current chroma block for the i^{th} chroma component, wherein i is a positive integer;
wherein the determining the first predicted value of the current chroma block based on the cross component intra prediction mode comprises: determining a first predicted value of the current chroma block for the i^{th} chroma component based on the cross component intra prediction mode; and
wherein the determining the second predicted value of the current chroma block based on the first predicted value and the limit range comprises: determining a second predicted value of the current chroma block for the i^{th} chroma component based on the first predicted value for the i^{th} chroma component and the limit range for the i^{th} chroma component.

12. The method according to claim 11, wherein before the determining, based on the chroma value of the surrounding reconstructed region for the i^{th} chroma component, the limit range of the predicted value of the current chroma block for the i^{th} chroma component, the method further comprises:
determining a first surrounding reconstructed region of the current chroma block for the i^{th} chroma component;
wherein the determining, based on the chroma value of the surrounding reconstructed region for the i^{th} chroma component, the limit range of the predicted value of the current chroma block for the i^{th} chroma component comprises:
determining the limit range of the predicted value of the current chroma block for the i^{th} chroma component based on the first surrounding reconstructed region.

13. The method according to claim 12, wherein the determining the first surrounding reconstructed region of the current chroma block for the i^{th} component comprises:
in a case that the prediction mode of the current chroma block is a convolutional cross component model mode, determining a second surrounding reconstructed region corresponding to the convolutional cross component model mode; and
determining the first surrounding reconstructed region based on the second surrounding reconstructed region.

14. The method according to claim 11, wherein the determining, based on the chroma value of the surrounding reconstructed region for the i^{th} chroma component, the limit range of the predicted value of the current chroma block for the i^{th} chroma component comprises:
determining that a maximum chroma value of the surrounding reconstructed region for the i^{th} chroma component is a maximum limit value of a predicted value of the current chroma block for the i^{th} chroma component; and/or
determining that a minimum chroma value of the surrounding reconstructed region for the i^{th} chroma component is a minimum limit value of a predicted value of the current chroma block for the i^{th} chroma component.

15. The method according to claim 11, wherein the limit range comprises the maximum limit value, and the determining the second predicted value of the current chroma block for the i^{th} chroma component based on the first predicted value for the i^{th} chroma component and the limit range for the i^{th} chroma component comprises:
in a case that the first predicted value is less than or equal to the maximum limit value, determining the first predicted value as the second predicted value; and
in a case that the first predicted value is greater than the maximum limit value, determining the maximum limit value as the second predicted value.

16. The method according to claim 11, wherein the limit range comprises the minimum limit value, and the determining the second predicted value of the current chroma block for the i^{th} chroma component based on the first predicted value for the i^{th} chroma component and the limit range for the i^{th} chroma component comprises:
in a case that the first predicted value is greater than the minimum limit value, determining the first predicted value as the second predicted value; and
in a case that the first predicted value is less than the minimum limit value, determining the minimum limit value as the second predicted value.

17. The method according to claim 11, wherein the limit range comprises the minimum limit value and the maximum limit value, and the determining the second predicted value of the current chroma block for the i^{th} chroma component based on the first predicted value for the i^{th} chroma component and the limit range for the i^{th} chroma component comprises:
in a case that the first predicted value is less than or equal to the maximum limit value and greater than or equal to the minimum limit value, determining the first predicted value as the second predicted value;
in a case that the first predicted value is greater than the maximum limit value, determining the maximum limit value as the second predicted value; and
in a case that the first predicted value is less than the minimum limit value, determining the minimum limit value as the second predicted value.

18. A video encoding method, comprising:
determining a prediction mode of a current chroma block;
in a case that the prediction mode is a cross component intra prediction mode, determining a limit range of a predicted value of the current chroma block based on a chroma value of a surrounding reconstructed region of the current chroma block, wherein the limit range comprises at least one of a maximum limit value or a minimum limit value of the predicted value;
determining a first predicted value of the current chroma block based on the cross component intra prediction mode; and
determining a second predicted value of the current chroma block based on the first predicted value and the limit range.

19. A computer-readable storage medium, storing a computer program/instruction and a bitstream, wherein the computer program/instruction is executed by a processor to implement the video encoding method according to claim 18 to generate the bitstream.
